(19) United States
(12) Patent Application Publication
(10) Pub. No.: US 2025/0108633 A1
(43) Pub. Date: Apr. 3, 2025

(54) CONVEYANCE CONTROL DEVICE, CONVEYANCE CONTROL METHOD, AND NON-TRANSITORY COMPUTER-READABLE MEDIUM STORING COMPUTER-READABLE INSTRUCTIONS

(71) Applicant: BROTHER KOGYO KABUSHIKI KAISHA, Nagoya (JP)

(72) Inventors: Daisuke KAWASE, Konan (JP); Shuichi TAMAKI, Nagoya (JP); Takuro YAMAZAKI, Anjo (JP); Tetsuro KOBAYASHI, Nagoya (JP)

(21) Appl. No.: 18/898,054

(22) Filed: Sep. 26, 2024

(30) Foreign Application Priority Data
Sep. 28, 2023 (JP) 2023-166794
Mar. 28, 2024 (JP) 2024-054959

(51) Int. Cl. B41J 11/00

(52) U.S. Cl. CPC B41J 11/007; B41J 11/0024

(57) ABSTRACT

A conveyance control device includes a conveyor, a first heater and a second heater, and a processor. The conveyor conveys a platen on which a print medium is placed. The first heater and the second heater are connected to a printer. The printer performs printing on the print medium on the platen. The first heater and the second heater execute a medium heating operation to heat the print medium on the platen. The processor controls the conveyor and conveys a target platen to one of the first heater or the second heater. The target platen is the platen on which the print medium is placed and is a control target.

### REFERENCE TO RELATED APPLICATIONS

This application claims priority from Japanese Patent Application No. 2023-166794 filed on Sep. 28, 2023 and Japanese Patent Application No. 2024-054959 filed on Mar. 28, 2024. The entire content of the priority application is incorporated herein by reference.

### BACKGROUND ART

A print device is provided with a conveyance unit, a head, a first heating unit, and a second heating unit. The conveyance unit conveys a print medium. The head performs printing on the print medium conveyed by the conveyance unit. The first heating unit is disposed upstream of the head in a conveyance direction, and heats the print medium in advance of the printing. The second heating unit is disposed downstream of the head in the conveyance direction, and heats the printed print medium.

### SUMMARY

In the above-described print device, the conveyance unit conveys the print medium such that the print medium passes both the first heating unit and the second heating unit. Thus, for example, if a heating time period by one of the heating units becomes longer, there is a possibility that productivity may deteriorate. Alternatively, for example, when a heating temperature of the heating unit differs for each of the print media, it is necessary to change the heating temperature of one of the heating units in accordance with the print medium. In this case, there is a possibility that an energy consumption amount due to the rise in the temperature of the heating unit may increase.

An object of the present disclosure is to provide a conveyance control device, a conveyance control method, and a non-transitory computer-readable medium storing computer-readable instructions that contribute to suppressing at least one of a deterioration in productivity or an increase in an energy consumption amount.

A first aspect of the present disclosure relates to a conveyance control device. The conveyance control device includes a conveyor, a first heater and a second heater, a processor, and a memory. The conveyor is configured to convey a platen on which a print medium is placed. The first heater and the second heater are connected to a printer. The printer is configured to perform printing on the print medium on the platen. The first heater and the second heater are configured to execute a medium heating operation to heat the print medium on the platen. The memory stores computer-readable instructions that, when executed by the processor, instruct the processor to perform a process. The process includes controlling the conveyor and conveying a target platen to one of the first heater or the second heater. The target platen is the platen on which the print medium is placed and is a control target.

According to the first aspect, the target platen is conveyed to one of the first heater or the second heater. Thus, the conveyance control device contributes to suppressing at least one of a deterioration in productivity or an increase in an energy consumption amount, in accordance with which of the first heater and the second heater the target platen is conveyed to.

A second aspect of the present disclosure relates to a conveyance control method of a conveyance control device. The conveyance control device includes a conveyor, a first heater, and a second heater. The conveyor is configured to convey a platen on which a print medium is placed. The first heater and the second heater are connected to a printer. the printer is configured to perform printing on the print medium on the platen. The first heater and the second heater are configured to execute a medium heating operation to heat the print medium on the platen. The conveyance control method includes conveyance processing of controlling the conveyor and conveying a target platen to one of the first heater or the second heater. The target platen is the platen on which the print medium is placed and is a control target.

The second aspect contributes to suppressing at least one of a deterioration in productivity or an increase in an energy consumption amount in the same way as the first aspect.

A third aspect of the present disclosure relates to a non-transitory computer-readable medium storing computer-readable instructions that, when executed by a computer, instruct the computer to perform a process. The computer controls a conveyance control device including a conveyor, a first heater, and a second heater. The conveyor is configured to convey a platen on which a print medium is placed. The first heater and the second heater are connected to a printer. the printer is configured to perform printing on the print medium on the platen. The first heater and the second heater are configured to execute a medium heating operation to heat the print medium on the platen. The process includes conveyance processing of controlling the conveyor and conveying a target platen to one of the first heater or the second heater. The target platen is the platen on which the print medium is placed and is a control target.

The third aspect contributes to suppressing at least one of a deterioration in productivity or an increase in an energy consumption amount in the same way as the first aspect.

### BRIEF DESCRIPTION OF DRAWINGS

FIG. 1 is a plan view schematically showing a print system.

FIG. 2 is a block diagram showing an electrical configuration of the print system.

FIG. 3 is a flowchart of main processing.

FIG. 4 is a flowchart of the main processing.

FIG. 5 is a flowchart of the main processing.

FIG. 6 is a flowchart of the main processing.

FIG. 7 is a flowchart of conveyance destination determination processing.

FIG. 8 is a flowchart of the conveyance destination determination processing.

FIG. 9 is a flowchart of the conveyance destination determination processing.

FIG. 10 is a flowchart of the conveyance destination determination processing.

FIG. 11 is a flowchart of the conveyance destination determination processing.

FIG. 12 is a concept diagram showing a set temperature.

FIG. 13 is a plan view schematically showing a print system.

FIG. 14 is a plan view schematically showing a print system.

### DESCRIPTION

Embodiments of the present disclosure will be described with reference to the drawings. In the present embodiment, mechanical elements in the drawings indicate an actual scale. Hereinafter, the upward direction, the downward direction, the leftward direction, the rightward direction, a depth direction on paper, and a front direction on paper are, respectively, a rearward direction, a forward direction, a leftward direction, a rightward direction, a downward direction, and an upward direction of a print system 1.

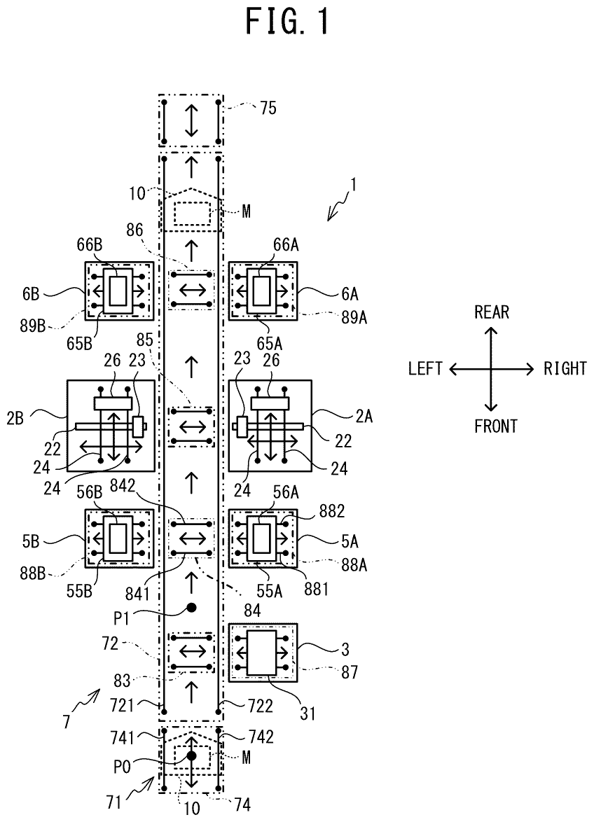

The print system 1 will be described with reference to FIG. 1. The print system 1 is a system that, while conveying a plurality of platens 10, sequentially performs application processing, treatment liquid drying processing, print processing, and ink drying processing, on print media M respectively placed on the plurality of platens 10, in the order of the application processing, the treatment liquid drying processing, the print processing, and the ink drying processing. The print medium M is cloth, or paper, for example, and is a T-shirt in the present embodiment. Each of the processing will be described in detail below.

The print system 1 is provided with the plurality of platens 10, a plurality of printers 2A and 2B, an application device 3, a first heating device 5A, a second heating device 5B, a first heating device 6A, a second heating device 6B, and a conveyance device 7. The platen 10 has a plate shape and extends in the front-rear direction and the left-right direction. The print medium M is placed on the upper surface of the platen 10.

The printer 2A, the application device 3, the first heating device 5A, and the first heating device 6A are aligned in the order of the application device 3, the first heating device 5A, the printer 2A, and the first heating device 6A, from the front toward the rear. The printer 2B, the second heating device 5B, and the second heating device 6B are aligned in the order of the second heating device 5B, the printer 2B, and the second heating device 6B, from the front toward the rear. The printer 2B is arranged to the left of the printer 2A. The second heating device 5B is arranged to the left of the first heating device 5A. The second heating device 6B is arranged to the left of the first heating device 6A.

Each of the printers 2A and 2B is a device that performs the print processing, and is an inkjet printer in the present embodiment. The print processing is processing to apply a liquid ink to the print medium M on the platen 10, and perform printing of an image. Each of the printers 2A and 2B is provided with a conveyance support base 23, a sub-scanning conveyance mechanism 22, an inkjet head 26, and a main scanning conveyance mechanism 24.

The platen 10 can be attached to and detached from the conveyance support base 23. The conveyance support base 23 supports the platen 10 in a state in which the platen 10 is mounted thereto. The sub-scanning conveyance mechanism 22 is a shaft extending in the left-right direction, for example, and supports the conveyance support base 23. The sub-scanning conveyance mechanism 22 conveys the conveyance support base 23 in a reciprocating manner in a sub-scanning direction. The sub-scanning direction is the left-right direction.

The inkjet head 26 discharges ink in the downward direction. The main scanning conveyance mechanism 24 is, for example, a pair of rails extending in the front-rear direction, and supports the inkjet head 26. The main scanning conveyance mechanism 24 conveys the inkjet head 26 in a reciprocating manner in a main scanning direction. The main scanning direction is the front-rear direction.

Each of the printers 2A and 2B conveys the conveyance support base 23, to which the platen 10 is mounted, in the left-right direction using the sub-scanning conveyance mechanism 22, and conveys the inkjet head 26 in the front-rear direction using the main scanning conveyance mechanism 24. In this way, the print medium M on the platen 10 is conveyed in the left-right direction and the front-rear direction relative to the inkjet head 26. The printers 2A and 2B discharge the ink in the downward direction from the inkjet head 26, in a state in which the print medium M on the platen 10 and the lower surface of the inkjet head 26 face each other in the up-down direction. In this way, the print processing is performed on the print medium M.

The application device 3 is a device that performs the application processing. The application processing is performed in advance of the print processing. The application processing is processing to apply a treatment liquid to the medium M on the platen 10. The treatment liquid is a base coat agent, and is, for example, an aqueous solution containing a cationic polymer or a polyvalent metal salt. The polyvalent metal salt is, for example, calcium chloride, or calcium nitrite. The treatment liquid improves fixing of the ink to the medium M and improves the color development of the ink.

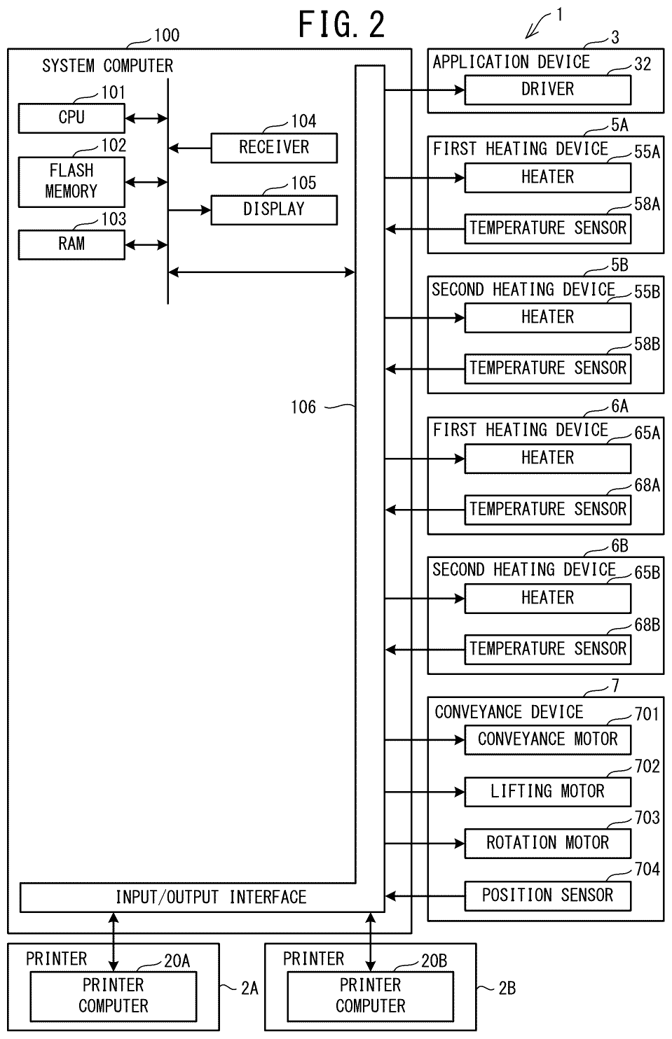

The application device 3 is provided with an application portion 31. The application portion 31 is a spray in the present embodiment, and sprays the treatment liquid by driving of a driver 32 shown in FIG. 2. The driver 32 is configured by a compressor and a solenoid valve, for example. Note that the application portion 31 may also be a discharge head, an application spatula, or the like.

In the application device 3, the application portion 31 sprays the treatment liquid onto the print medium M on the platen 10 in a state in which the platen 10 is disposed directly below the application portion 31. In this way, the application processing of applying the treatment liquid to the print medium M is performed.

Each of the first heating device 5A and the second heating device 5B is a device that performs the treatment liquid drying processing. The treatment liquid drying processing is performed in advance of the print processing and subsequent to the application processing. The treatment liquid drying processing is processing to heat the print medium M on the platen 10, in order to vaporize the moisture content in the treatment liquid applied to the print medium M by the application processing. In this way, the fixing of a solute in the treatment liquid to the print medium M is improved.

Each of the first heating device 5A and the second heating device 5B is an air blower dryer. The first heating device 5A is provided with a heater 55A and a fan 56A. Similarly, the second heating device 5B is provided with a heater 55B and a fan 56B. Each of the heaters 55A and 55B is a heater resistor, and generates heat by being electrically energized. Each of the heaters 55A and 55B heats air. Each of the fans 56A and 56B is an air blower. The fan 56A blows the air heated by the heater 55A into the first heating device 5A. The fan 56B blows the air heated by the heater 55B into the second heating device 5B.

In the first heating device 5A and the second heating device 5B, in a state in which the platen 10 is housed inside the first heating device 5A and inside the second heating device 5B, the air heated by the heaters 55A and 55B is blown into the first heating device 5A and the second heating device 5B by the fans 56A and 56B, respectively. In this way, the treatment liquid drying processing, which dries the print medium M in a high-temperature atmosphere and vaporizes the moisture content in the treatment liquid, is performed by each of the first heating device 5A and the second heating device 5B.

Each of the first heating device 6A and the second heating device 6B is a device that performs the ink drying processing. The ink drying processing is performed subsequent to the print processing. The ink drying processing is processing that heats the print medium M on the platen 10, and vaporizes the moisture content in the ink applied to the print medium M by the print processing. In this way, the fixing of a pigment or dye in the ink to the print medium Mis improved.

Each of the first heating device 6A and the second heating device 6B is an air blower dryer. The first heating device 6A is provided with a heater 65A and a fan 66A. Similarly, the second heating device 6B is provided with a heater 65B and a fan 66B. Each of the heaters 65A and 65B is a heater resistor, and generates heat by being electrically energized. Each of the heaters 65A and 65B heats air. Each of the fans 66A and 66B is an air blower. The fan 66A blows the air heated by the heater 65A into the first heating device 6A. The fan 66B blows the air heated by the heater 65B into the second heating device 6B.

In the first heating device 6A and the second heating device 6B, in a state in which the platen 10 is housed inside the first heating device 6A and inside the second heating device 6B, the air heated by the heaters 65A and 65B is blown into the first heating device 6A and the second heating device 6B by the fans 66A and 66B, respectively. In this way, the ink drying processing, which dries the print medium M in a high-temperature atmosphere and vaporizes the moisture content in the ink, is performed by each of the first heating device 6A and the second heating device 6B.

The conveyance device 7 is configured by conveyance paths of the platen 10, and conveys the platen 10 such that the application processing, the treatment liquid drying processing, the print processing, and the ink drying processing are sequentially performed. The conveyance device 7 is provided with a main path 71, transfer mechanisms 83 to 86, and branch paths 87, 88A, 88B, 89A, and 89B. The main path 71 has a two-level structure, and is provided with an outward path 72, a return path (not shown in the drawings), and elevator mechanisms 74 and 75.

The outward path 72 is a second level portion, and extends in the front-rear direction between the printers 2A and 2B, to the left of the application device 3, between the first heating device 5A and the second heating device 5B, and between the first heating device 6A and the second heating device 6B. The outward path 72 extends from a position further to the front than the application device 3 to a position further to the rear than each of the first heating device 6A and the second heating device 6B. The return path is a first level portion, and extends from a position further to the front than the application device 3 to a position further to the rear than the each of the first heating device 6A and the second heating device 6B. In other words, the return path is disposed directly below the outward path 72, and extends in parallel to the outward path 72.

The outward path 72 conveys the platen 10 from the front toward the rear by driving of a conveyance motor 701 of the outward path 72 shown in FIG. 2. In the present embodiment, the outward path 72 is configured by a pair of belt conveyors 721 and 722. The belt conveyor 721 is disposed at the left end of the outward path 72. The belt conveyor 722 is disposed at the right end of the outward path 72. The pair of belt conveyors 721 and 722 extend in the front-rear direction in parallel to each other. Rotation shafts of each of the pair of belt conveyors 721 and 722 extend in the left-right direction. The return path has the same structure as that of the outward path 72. The return path conveys the platen 10 from the rear toward the front by driving of a conveyance motor 701 of the return path shown in FIG. 2.

The elevator mechanism 74 is disposed at the front end of the main path 71. The elevator mechanism 75 is disposed at the rear end of the main path 71. Thus, the outward path 72 and the return path are disposed between the elevator mechanism 74 and the elevator mechanism 75 in the front-rear direction. The elevator mechanisms 74 and 75 move up and down, by driving of respective lifting motors 702 shown in FIG. 2, to a position at the same height as the outward path 72 (the second level portion) and a position at the same height as the return path (the first level portion). Furthermore, the elevator mechanisms 74 and 75 convey the platen 10 in the front-rear direction by driving of respective conveyance motors 701 shown in FIG. 2.

In the present embodiment, the elevator mechanism 74 is configured by a pair of belt conveyors 741 and 742. The belt conveyor 741 is disposed at the left end of the elevator mechanism 74. The belt conveyor 742 is disposed at the right end of the elevator mechanism 74. The pair of belt conveyors 741 and 742 extend in the front-rear direction in parallel to each other. Rotation shafts of each of the pair of belt conveyors 741 and 742 extend in the left-right direction. The elevator mechanism 75 has the same structure as that of the elevator mechanism 74. Thus, a description of the structure of the elevator mechanism 75 will be omitted.

The transfer mechanisms 83 to 86 are disposed between the pair of belt conveyors 721 and 722 in the left-right direction. The transfer mechanisms 83 to 86 are arranged in the order of the transfer mechanisms 83, 84, 85, and 86, from the front to the rear, in the outward path 72. Each of the transfer mechanisms 83 and 86 conveys the platen 10 in the left-right direction. The transfer mechanism 83 transfers the platen 10 between the outward path 72 and a branched path 87 to be described later. The transfer mechanism 84 transfers the platen 10 between the outward path 72 and a branched path 88A or a branched path 88B to be described later. The transfer mechanism 85 transfers the platen 10 between the outward path 72 and the conveyance support base 23 of the printer 2A or the printer 2B. The transfer mechanism 86 transfers the platen 10 between the outward path 72 and a branched path 89A or a branched path 89B to be described later.

By driving of the lifting motor 702 of the transfer mechanism 84 shown in FIG. 2, the transfer mechanism 84 moves up and down between a position lower than the outward path 72 and a position higher than the outward path 72. Furthermore, by driving of a rotation motor 703 of the transfer mechanism 84 shown in FIG. 2, the transfer mechanism 84 rotates the platen 10 on the transfer mechanism 84 in the clockwise direction or the counterclockwise direction in a plan view. The transfer mechanism 84 switches an orientation of the platen 10 such that the rear of the platen 10, that is, the rear surface of a back plate 65, is oriented in an advancing direction of the platen 10.

In the present embodiment, the transfer mechanism 84 is configured by a pair of belt conveyors 841 and 842. The belt conveyor 841 is disposed at the front end of the transfer mechanism 84. The belt conveyor 842 is disposed at the rear end of the transfer mechanism 84. The pair of belt conveyors 841 and 842 extend in the left-right direction in parallel to each other. Rotation shafts of each of the pair of belt conveyors 841 and 842 extend in the front-rear direction. Each of the transfer mechanisms 83, 85, and 86 has the same structure as that of the transfer mechanism 84. Thus, a description of the structure of the transfer mechanisms 83, 85, and 86 will be omitted.

The branched path 87 is disposed to the right and adjacent to the transfer mechanism 83, and branches to the right from the main path 71. The branched path 87 extends to the interior of the application device 3. The branched path 88A is disposed to the right and adjacent to the transfer mechanism 84, and branches to the right from the main path 71. The branched path 88A extends to the interior of the first heating device 5A. The branched path 88B is disposed to the left and adjacent to the transfer mechanism 84, and branches to the left from the main path 71. The branched path 88B extends to the interior of the second heating device 5B. The branched path 89A is disposed to the right and adjacent to the transfer mechanism 86, and branches to the right from the main path 71. The branched path 89A extends to the interior of the first heating device 6A. The branched path 89B is disposed to the left and adjacent to the transfer mechanism 86, and branches to the left from the main path 71. The branched path 89B extends to the interior of the second heating device 6B. Each of the branched paths 87, 88A, 88B, 89A, and 89B conveys the platen 10 in the left-right direction.

In the present embodiment, the branched path 88A is configured by a pair of belt conveyors 881 and 882. The belt conveyor 881 is disposed at the front end of the branched path 88A. The belt conveyor 882 is disposed at the rear end of the branched path 88A. The pair of belt conveyors 881 and 882 extend in the left-right direction in parallel to each other. Rotation shafts of each of the pair of belt conveyors 881 and 882 extend in the front-rear direction. Each of the branched paths 87, 88B, 89A, and 89B has the same structure as that of the branched path 88A. Thus, a description of the structure of the branched paths 87, 88B, 89A, and 89B will be omitted here.

According to the configuration of the above-described conveyance device 7, the first heating device 5A is connected to the application device 3 via the branched path 88A, the transfer mechanism 84, the outward path 72, the transfer mechanism 83, and the branched path 87. The first heating device 5A is connected to each of the printers 2A and 2B via the branched path 88A, the transfer mechanism 84, the outward path 72, and the transfer mechanism 85. The second heating device 5B is connected to the application device 3 via the branched path 88B, the transfer mechanism 84, the outward path 72, the transfer mechanism 83, and the branched path 87. The second heating device 5B is connected to each of the printers 2A and 2B via the branched path 88B, the transfer mechanism 84, the outward path 72, and the transfer mechanism 85.

The first heating device 6A is connected to each of the printers 2A and 2B via the branched path 89A, the transfer mechanism 86, the outward path 72, and the transfer mechanism 85. The second heating device 6B is connected to each of the printers 2A and 2B via the branched path 89B, the transfer mechanism 86, the outward path 72, and the transfer mechanism 85.

A flow of operations of the print system 1 will be described. Hereinafter, for convenience, at a start of the operations of the print system 1, it is assumed that each of the transfer mechanisms 83 to 85 is disposed lower than the outward path 72, and each of the elevator mechanisms 74 and 75 is disposed at the same height as the outward path 72.

Hereinafter, the position of the platen 10 when the print medium M is placed on the platen 10 will be referred to as a “set position P0”. In the present embodiment, the set position P0 is disposed on the elevator mechanism 74. Note that, when the elevator mechanism 74 is taken as an origin point in terms of upstream and downstream, for example, the set position P0 may be disposed further upstream than the transfer mechanism 83 and the like, and the application device 3, on the outward path 72. As will be described later, the platen 10 is conveyed from the elevator mechanism 74 in order of the outward path 72, the elevator mechanism 75, and the return path that is not shown in the drawings, and returns to the elevator mechanism 74. Thus, in the main path 71, the set position P0 may be disposed at a position further downstream than each of the first heating device 6A and the second heating device 6B, or may be disposed on the return path that is not shown in the drawings. In the present embodiment, a user places the print medium M on the platen 10 in a state in which the platen 10 is disposed at the set position P0, namely, is disposed on the elevator mechanism 74. In the state in which the print medium M is placed on the platen 10, the elevator mechanism 74 conveys the platen 10 to the rear, and transfers the platen 10 to the outward path 72.

The outward path 72 conveys the platen 10 to the rear to the transfer mechanism 83. The transfer mechanism 83 moves up to a position higher than the outward path 72. In this way, the platen 10 is transferred from the outward path 72 to the transfer mechanism 83. The transfer mechanism 83 rotates the platen 10 by 90° in the clockwise direction in a plan view, and conveys the platen 10 to the right to the branched path 87. The transfer mechanism 83 moves down to a position less than the branched path 87. In this way, the platen 10 is transferred from the transfer mechanism 83 to the branched path 87. The application device 3 performs the application processing.

When the application processing by the application device 3 is complete, the branched path 87 conveys the platen 10 to the left to the transfer mechanism 83. The transfer mechanism 83 moves up to a position higher than the branched path 87. In this way, the platen 10 is transferred from the branched path 87 to the transfer mechanism 83. The transfer mechanism 83 rotates the platen 10 by 90° in the counterclockwise direction in a plan view, and moves down to a position less than the outward path 72. In this way the platen 10 is transferred from the transfer mechanism 83 to the outward path 72.

A mode of transfer of the platen 10 by each of the transfer mechanisms 84 and 85 is the same as the mode of transfer of the platen 10 by the transfer mechanism 83. Thus, hereinafter, a description of the transfer of the platen 10 by each of the transfer mechanisms 84 and 85 will be omitted or simplified.

The outward path 72 conveys the platen 10 to the rear and transfers the platen 10 to the transfer mechanism 84. The transfer mechanism 84 conveys the platen 10 to the right or to the left, and transfers the platen 10 to the branched path 88A or to the branched path 88B. In other words, the transfer mechanism 84 is a branch point between conveying the platen 10 to the first heating device 5A or conveying the platen 10 to the second heating device 5B. The first heating device 5A or the second heating device 5B to which the platen 10 has been conveyed performs the treatment liquid drying processing. When the treatment liquid drying processing by the first heating device 5A or the second heating device 5B is complete, the branched path 88A conveys the platen 10 to the left, or the branched path 88B conveys the platen 10 to the right, and transfers the platen 10 to the transfer mechanism 84. The transfer mechanism 84 transfers the platen 10 to the outward path 72.

The outward path 72 conveys the platen 10 to the rear and transfers the platen 10 to the transfer mechanism 85. The transfer mechanism 85 conveys the platen 10 to the right or to the left, and transfers the platen 10 to the conveyance support base 23 of the printer 2A or the printer 2B. In other words, the transfer mechanism 85 is a branch point between conveying the platen 10 to the printer 2A or conveying the platen 10 to the printer 2B. The printer 2A or the printer 2B to which the platen 10 has been conveyed performs the print processing. When the print processing by the printer 2A or the printer 2B is complete, the conveyance support base 23 of the printer 2A conveys the platen 10 to the left, or the conveyance support base 23 of the printer 2B conveys the platen 10 to the right, and transfers the platen 10 to the transfer mechanism 85. The transfer mechanism 85 transfers the platen 10 to the outward path 72.

The outward path 72 conveys the platen 10 to the rear and transfers the platen 10 to the transfer mechanism 86. The transfer mechanism 86 conveys the platen 10 to the right or to the left, and transfers the platen 10 to the branched path 89A or the branched path 89B. In other words, the transfer mechanism 86 is a branch point between conveying the platen 10 to the first heating device 6A or conveying the platen 10 to the second heating device 6B. The first heating device 6A or the second heating device 6B to which the platen 10 has been conveyed performs the ink drying processing. When the ink drying processing by the first heating device 6A or the second heating device 6B is complete, the branched path 89A conveys the platen 10 to the left, or the branched path 89B conveys the platen 10 to the right, and transfers the platen 10 to the transfer mechanism 86. The transfer mechanism 86 transfers the platen 10 to the outward path 72.

The outward path 72 conveys the platen 10 to the rear and transfers the platen 10 to the elevator mechanism 75. The elevator mechanism 75 moves down to the same height as the return path that is not shown in the drawings. The elevator mechanism 75 conveys the platen 10 to the front and transfers the platen 10 to the return path. The return path conveys the platen 10 to the front in a state in which the elevator mechanism 74 is at the same height as the return path, and transfers the platen 10 to the elevator mechanism 74.

The user removes the print medium M on which the image has been printed from the platen 10, during a period in which the platen 10 is being conveyed from the elevator mechanism 75 to the elevator mechanism 74 via the return path. For example, the user removes the print medium M on which the image has been printed from the platen 10 in a state in which the platen 10 is disposed on the elevator mechanism 75. Subsequently, the user places the print medium M, on which the printing is next to be performed, on the platen 10 in the state in which the platen 10 is disposed at the set position P0, namely, is disposed on the elevator mechanism 74. The same operations by the print system 1 are subsequently repeated.

The electrical configuration of the print system 1 will be described with reference to FIG. 2. The print system 1 is provided with a system computer 100, and printer computers 20A and 20B. The system computer 100 is provided on a control board that is not shown in the drawings, for example, and controls each of the application device 3, the first heating device 5A, the second heating device 5B, the first heating device 6A, the second heating device 6B, and the conveyance device 7. The printer computer 20A is provided in the printer 2A and controls the printer 2A. The printer computer 20B is provided in the printer 2B and controls the printer 2B. The system computer 100 and the printer computers 20A and 20B communicate with each other in a wired or wireless manner.

The system computer 100 is provided with a CPU 101, a flash memory 102, a RAM 103, a receiver 104, and a display 105. The CPU 101 functions as a processor. The CPU 101 is electrically connected to the flash memory 102, the RAM 103, the receiver 104, and the display 105.

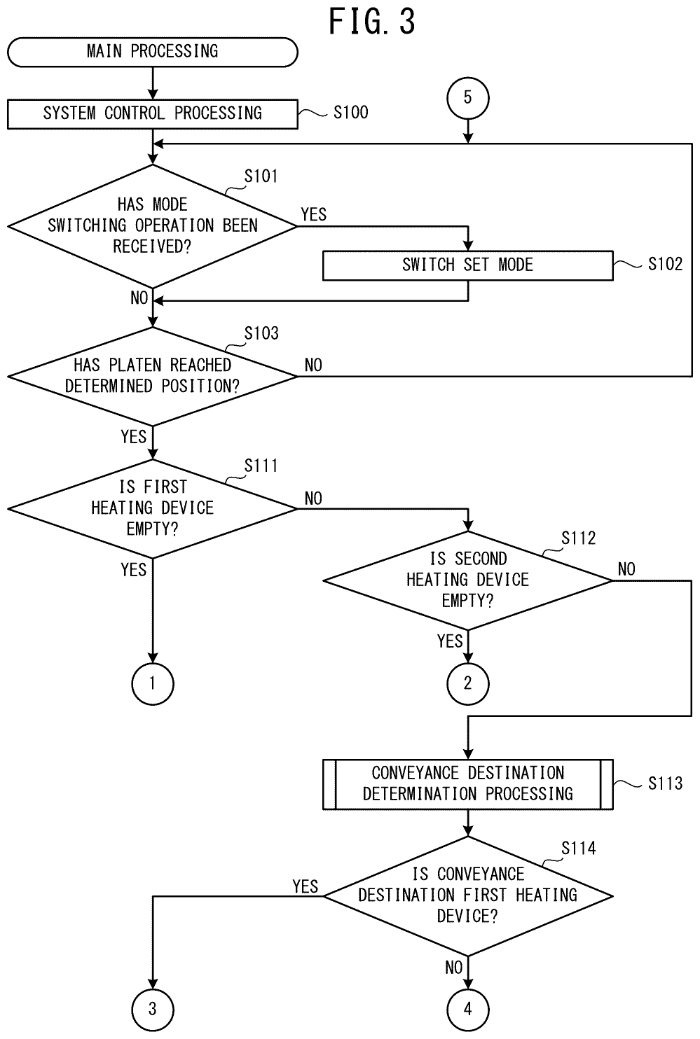

The flash memory 102 is a non-volatile storage medium, and stores various information. For example, programs are stored in the flash memory 102. The programs include a conveyance control program for performing main processing to be described later and shown in FIG. 3, and are executed by the CPU 101. The RAM 103 is a volatile storage medium, and temporarily stores various information. For example, information that is calculated, acquired, identified, determined, received, or accepted by the CPU 101 during execution of the main processing (to be described later) is stored in the RAM 103.

The receiver 104 is a user interface, and includes a touch panel, a power supply button, and the like. The user operates the receiver 104, and inputs various commands to the system computer 100. The display 105 displays various information under the control of the CPU 101.

The driver 32, the heaters 55A, 55B, 65A, and 65B, temperature sensors 58A, 58B, 68A, and 68B, the conveyance motor 701, the lifting motor 702, the rotation motor 703, a position sensor 704, the printer computer 20A, and the printer computer 20B are each electrically connected to the CPU 101, via an input/output interface 106. The driver 32 is driven under control of the CPU 101, and causes the treatment liquid to be sprayed from the application portion 31 shown in FIG. 1.

The heaters 55A, 55B, 65A, and 65B generate heat under control of the CPU 101, and heat the air. The temperature sensor 58A is provided inside the first heating device 5A. The temperature sensor 58A detects the temperature of the atmosphere inside the first heating device 5A, and outputs a signal indicating the detected temperature to the CPU 101. Similarly, the temperature sensors 58B, 68A, and 68B are provided inside the second heating device 5B, inside the first heating device 6A, and inside the second heating device 6B, respectively. The temperature sensors 58B, 68A, and 68B respectively detect the temperature of the atmosphere inside the second heating device 5B, inside the first heating device 6A, and inside the second heating device 6B, and output signals indicating the detected temperature to the CPU 101. Hereinafter, the temperature detected by the temperature sensors 58A, 58B, 68A, and 68B will be referred to as the “detected temperature”. For example, the detected temperature of the first heating device 5A is the temperature detected by the temperature sensor 58A, and is the temperature inside the first heating device 5A.

A number of the conveyance motors 701 is a plurality. The plurality of conveyance motors 701 are provided in the outward path 72 shown in FIG. 1, the return path that is not shown in the drawings, the elevator mechanisms 74 and 75, the transfer mechanisms 83 to 86, and the branched paths 87, 88A, 88B, 89A, and 89B, respectively. Each of the plurality of conveyance motors 701 is driven under control of the CPU 101, and conveys the platen 10. For example, the conveyance motor 701 of the outward path 72 conveys the platen 10 on the outward path 72 as a result of the conveyance motor 701 being driven.

A number of the lifting motors 702 is a plurality. The plurality of lifting motors 702 are provided in the elevator mechanisms 74 and 75 shown in FIG. 1, and the transfer mechanisms 83 to 86, respectively. Each of the plurality of lifting motors 702 is driven under control of the CPU 101, and raises and lowers the platen 10. For example, the lifting motor 702 of the elevator mechanism 74 raises and lower the platen 10 on the elevator mechanism 74 as a result of the lifting motor 702 being driven.

A number of the rotation motors 703 is a plurality. The plurality of rotation motors 703 are provided in the transfer mechanisms 83 to 86 shown in FIG. 1, respectively. The plurality of rotation motors 703 are driven under control of the CPU 101, and rotate the platen 10 in the clockwise direction or the counterclockwise direction in a plan view. For example, the rotation motor 703 of the transfer mechanism 84 rotates the platen 10 on the transfer mechanism 84 as a result of the rotation motor 703 being driven.

A number of the position sensors 704 is a plurality. Each of the plurality of position sensors 704 may be one of a limit switch, a proximity sensor, an optical sensor, or the like, and the position sensors 704 are provided in the outward path 72 shown in FIG. 1, the return path that is not shown in the drawings, the elevator mechanisms 74 and 75, the transfer mechanisms 83 to 86, the branched paths 87, 88A, 88B, 89A, and 89B, and a determination position P1 to be described later and shown in FIG. 1, respectively. The plurality of position sensors 704 detect the presence of the platen 10 at the positions at which each of the plurality of position sensors 704 are provided, and each outputs a signal indicating a detection result to the CPU 101. For example, when the position sensor 704 of the branched path 88A detects the platen 10 on the branched path 88A, the position sensor 704 outputs, to the CPU 101, the signal indicating that the platen 10 is present on the branched path 88A.

The main processing will be described with reference to FIG. 3 to FIG. 7. When the power supply to the system computer 100 is turned on, the CPU 101 starts the main processing by reading out and operating the conveyance control program from the flash memory 102. In the main processing, the control of the application device 3, the control of the first heating device 5A and the second heating device 5B, the control of the first heating device 6A and the second heating device 6B, and the control of the conveyance device 7 and the like are performed. Hereinafter, of the main processing, processing relating to the control of the first heating device 5A and the second heating device 5B, and to the control of the conveyance device 7 will be mainly described. When either of the first heating device 5A and the second heating device 5B is not particularly distinguished, the device will simply be referred to as the “heating device”.

If, for example, the plurality of platens 10 are always conveyed to one of the first heating device 5A or the second heating device 5B, there is a possibility that a time until the print processing on the plurality of print media M is complete may become longer. In other words, there is a possibility that productivity of the print processing may deteriorate. In order to suppress the deterioration in productivity, the CPU 101 performs the main processing to be described below.

As shown in FIG. 3, when the main processing is started, the CPU 101 performs system control processing (S100). The system control processing includes conveyance processing of the platen 10 by the conveyance device 7 upstream of the determination position P1 to be described below, the application processing by the application device 3, the conveyance processing of the platen 10 by the conveyance device 7 downstream of each of the first heating device 5A and the second heating device 5B, the ink drying processing by the first heating device 6A and the second heating device 6B, and the like. Each of the processing included in the system control processing is performed in parallel with processing performed from S101 onward.

The CPU 101 determines whether a mode switching operation for switching a set mode has been received via the receiver 104 shown in FIG. 2 (S101). The set mode is a mode set by the user, from among a plurality of modes, and is stored in the flash memory 102. The plurality of modes respectively specify a priority when determining a conveyance destination of a target platen to be described later. In the present embodiment, the plurality of modes include a productivity mode and an energy saving mode. The productivity mode specifies, as the priority, an improvement in productivity in the heating device. The energy saving mode specifies, as the priority, a suppression of energy consumption in the heating device.

When the mode switching operation has not been received (no at S101), the CPU 101 shifts the processing to a determination at S103. When the mode switching operation has been received (yes at S101), the CPU 101 switches the set mode in the flash memory 102 (S102). For example, when the mode switching operation is received in a state in which the set mode is the productivity mode, the CPU 101 switches the set mode from the productivity mode to the energy saving mode. For example, when the mode switching operation is received in a state in which the set mode is the energy saving mode, the CPU 101 switches the set mode from the energy saving mode to the productivity mode. The CPU 101 shifts the processing to the determination at S103.

As shown in FIG. 1, in the present embodiment, in the conveyance device 7, the determination position P1 is provided at any position from the set position P0 shown in FIG. 1 to the transfer mechanism 84. The determination position P1 may be disposed at the application device 3, that is, on the branched path 87, may be disposed on the transfer mechanism 83 or the transfer mechanism 84, or may be disposed on the elevator mechanism 74, that is, at the set position P0. In the present embodiment, the determination position P1 is disposed downstream of the transfer mechanism 83 and upstream of the transfer mechanism 84 in the outward path 72. In other words, in the present embodiment, in the conveyance device 7, the determination position P1 is disposed at a position through which the platen 10 on which the application processing has not yet been performed by the application device 3 does not pass, and through which the platen 10 on which the application processing has been performed by the application device 3 does pass.

As shown in FIG. 3, in the determination at S103, the CPU 101 determines that the platen 10 conveyed by the system control processing at S100 has reached the determination position P1 based on the detection signal from the position sensor 704 of the determination position P1 (S103). Hereinafter, the platen 10 that has reached the determination position P1 will be referred to as a “target platen”. Specifically, the target platen is the platen 10 that is present on the determination position P1 at the time point of the determination at S103, and is the platen 10 that is to be a control target in the processing from S111 onward in the main processing. In other words, the target platen is the platen 10 that is a target for determining which of the first heating device 5A and the second heating device 5B is to be a conveyance destination, and is a target to be conveyed to the determined conveyance destination.

When the platen 10 has not reached the determination position P1 (no at S103), the CPU 101 returns the processing to the determination at S101. When the platen 10 has reached the determination position P1 (yes at S103), the CPU 101 shifts the processing to a determination at S111. When the platen 10 has reached the determination position P1 (yes at S103), the CPU 101 may stop the conveyance of the target platen at the determination position P1, or may maintain the conveyance of the target platen without stopping the conveyance of the target platen at the determination position P1.

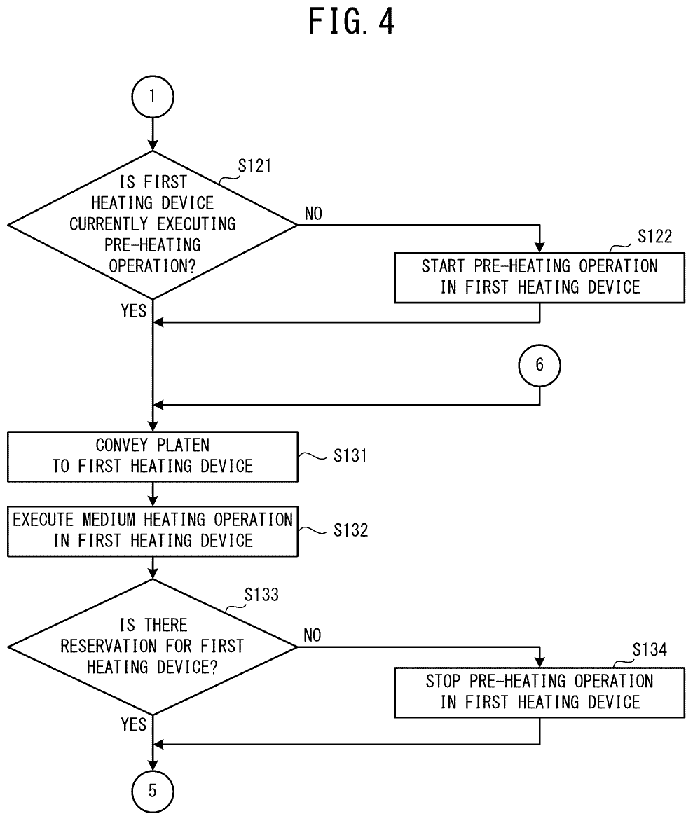

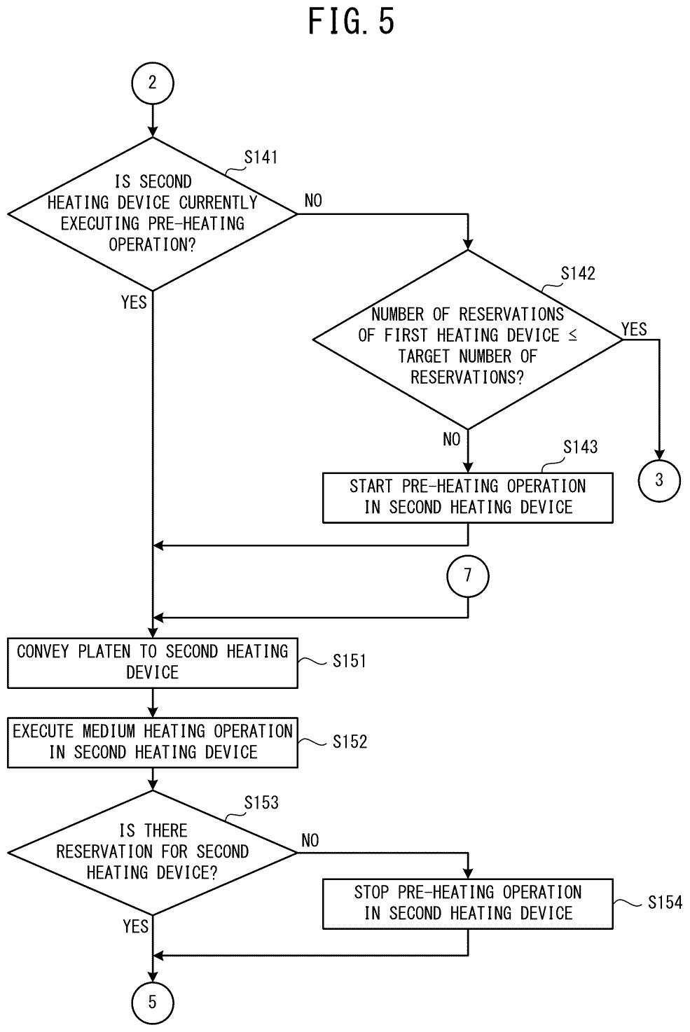

For example, when the conveyance of the target platen is maintained, there is a possibility that the target platen may reach the transfer mechanism 84 during a period before the conveyance of the target platen to the first heating device 5A is started by processing at S131 shown in FIG. 4 and to be described later, or during a period before the conveyance of the target platen to the second heating device 5B is started, by processing at S151 shown in FIG. 5 and to be described later. Before the processing at S131 or at S151, the CPU 101 stops the target platen at a position, from the determination position P1, that is further upstream than the transfer mechanism 84. The CPU 101 performs the processing until the processing at S131 or S151 at the position at which the target platen is stopped, from the determination position P1, further upstream than the transfer mechanism 84. As long as the platen 10 that is not the target platen is at a position at which the platen 10 can be transferred from the branched path 88A or the branched path 88B to the transfer mechanism 84, the CPU 101 may stop the target platen even on the transfer mechanism 84. In other words, the CPU 101 performs the processing from S111 up to S131 or the processing from S111 up to S115 in a state in which the target platen is placed at any position from the determination position P1 to the transfer mechanism 84 in the conveyance device 7.

A heating operation will be described. The heating operation by the first heating device 5A is an operation that causes the heater 55A to generate heat. The heating operation by the second heating device 5B is an operation that causes the heater 55B to generate heat. The heating operation includes a medium heating operation and a pre-heating operation.

The medium heating operation is a heating operation that maintains a power supply amount to the heater 55A or to the heater 55B such that the detected temperature is a corresponding set temperature, and heats the print medium M at the corresponding set temperature. The corresponding set temperature is a set temperature corresponding to the print medium M placed on the target platen, of a plurality of set temperatures corresponding to the print media M. The medium heating operation by the first heating device 5A is executed in a state in which the print medium M is housed in the first heating device 5A. The medium heating operation by the second heating device 5B is executed in a state in which the print medium Mis housed in the second heating device 5B. In the present embodiment, an execution reservation for the medium heating operation can be set. The execution reservation for the medium heating operation is stored in the RAM 103.

The pre-heating operation is a heating operation that controls the power supply amount to the heater 55A or the heater 55B, such that the detected temperature rises to the corresponding set temperature before the medium heating operation. The pre-heating operation by the first heating device 5A is executed in a state in which the print medium M is not housed in the first heating device 5A. The pre-heating operation by the second heating device 5B is executed in a state in which the print medium M is not housed in the second heating device 5B.

An “empty heating device” will be defined. The empty heating device is the heating device in which the medium heating operation is not currently being executed and for which no execution reservation for the medium heating operation is set. When the execution reservation for the medium heating operation is not set, this means that a number of execution reservations for the medium heating operation is “zero”. In other words, when the execution reservation for the medium heating operation is not set, this means that there is no reservation to convey the target platen in the processing at S131 or S151 to be described later. The heating device that is not the empty heating device is one of the heating device in which the medium heating operation is currently being executed and for which no execution reservation for the medium heating operation is set, is the heating device in which the medium heating operation is not currently being executed and for which the execution reservation for the medium heating operation is set, or is the heating device in which the medium heating operation is currently being executed and for which the execution reservation for the medium heating operation is set.

When the target platen is to be conveyed to the empty heating device, it is not necessary for the target platen to stand by until the medium heating operation is executed. Thus, as to be described below, when the empty heating device is available, in principle, control is performed to convey the target platen to the empty heating device.

The CPU 101 determines whether the first heating device 5A is the empty heating device (S111). When the first heating device 5A is the empty heating device (yes at S111), the CPU 101 shifts the processing to S121 shown in FIG. 4, and performs each of processing to convey the target platen to the first heating device 5A. When the first heating device 5A is not the empty heating device (no at S111), the CPU 101 determines whether the second heating device 5B is the empty heating device (S112). When the second heating device 5B is the empty heating device (yes at S112), the CPU 101 shifts the processing to a determination at S141 shown in FIG. 5. In this case, the CPU 101 performs each of processing to determine whether to convey the target platen to the first heating device 5A or the second heating device 5B, in accordance with the number of execution reservations for the medium heating operation in the first heating device 5A.

When the second heating device 5B is not the empty heating device (no at S112), the CPU 101 performs conveyance destination determination processing (S113). As will be described in detail later, in the conveyance destination determination processing, the conveyance destination of the target platen is determined to be either the first heating device 5A or the second heating device 5B, based on whether the set mode is the productivity mode or the energy saving mode.

A case will be described in which the first heating device 5A is the empty heating device (yes at S111). As shown in FIG. 4, the CPU 101 determines whether the first heating device 5A is currently executing the pre-heating operation (S121). At the start of the main processing, for example, the first heating device 5A is not yet executing the pre-heating operation. When the first heating device 5A is not currently executing the pre-heating operation (no at S121), the CPU 101 starts the pre-heating operation in the first heating device 5A (S122). The CPU 101 shifts the processing to the processing at S131. When the first heating device 5A is currently executing the pre-heating processing (yes at S121), the CPU 101 shifts the processing to the processing at S131.

The CPU 101 conveys the target platen to the first heating device 5A (S131). For example, when the application processing by the application device 3 has not yet been performed on the target platen, the processing at S131 is performed subsequent to the application processing. In the processing at S131, the target platen is disposed on the transfer mechanism 84 shown in FIG. 1. In this state, the conveyance motor 701 of the transfer mechanism 84 is controlled, and the target platen is conveyed to the right and transferred to the branched path 88A. When the target platen is transferred to the branched path 88A and is conveyed to the first heating device 5A, the CPU 101 executes the medium heating operation in the first heating device 5A (S132). When the medium heating operation in the first heating device 5A is complete, the CPU 101 shifts the processing to a determination at S133.

A “non-operating heating device” will be defined. The non-operating heating device is the heating device for which there is no execution reservation for the medium heating operation. When the non-operating heating device is present, the CPU 101 stops the heating operation by the non-operating heating device. Thus, when the medium heating operation is complete, the CPU 101 refers to the RAM 103, and determines whether there is the execution reservation for the medium heating operation in the first heating device 5A (S133). When there is no execution reservation for the medium heating operation in the first heating device 5A (no at S133), the CPU 101 stops the pre-heating operation in the first heating device 5A (S134). In this way, the temperature inside the first heating device 5A naturally falls. The CPU 101 returns the processing to the determination at S101 shown in FIG. 3.

When there is the execution reservation for the medium heating operation in the first heating device 5A (yes at S133), the CPU 101 skips the processing at S134, and returns the processing to the determination at S101 shown in FIG. 3. In this case, using the pre-heating operation in the first heating device 5A, or using the natural cooling in the first heating device 5A, the power supply to the heater 55A is controlled, namely, the heating or the stopping of the heater 55A is controlled, such that the detected temperature of the first heating device 5A becomes the next corresponding set temperature in the first heating device 5A. The next corresponding set temperature in the first heating device 5A is the set temperature corresponding to the print medium M placed on the platen 10 subsequent to the platen 10 for which the medium heating operation is complete in the processing at S132, in an execution order of the medium heating operation in the first heating device 5A.

A case will be described in which the second heating device 5B is the empty heating device (yes at S112). For example, when a number of times the medium heating operation is executed within a predetermined time period in the first heating device 5A is equal to or less than a target number of times the medium heating operation is to be executed in the predetermined time period (hereinafter referred to as a “target number of times of execution”) in the first heating device 5A, it is not necessary to execute the medium heating operation in the second heating device 5B. In this case, when the state is maintained in which the second heating device 5B has stopped the heating operation, the print system 1 can execute the medium heating operation for the target number of times of execution without incurring an energy consumption required to raise the temperature inside the second heating device 5B to the corresponding set temperature. Thus, even when the second heating device 5B is the empty heating device, as described below, the CPU 101 determines whether to convey the platen 10 to the second heating device 5B in accordance with the target number of times of execution.

As shown in FIG. 5, the CPU 101 determines whether the second heating device 5B is currently executing the pre-heating operation (S141). When the second heating device 5B is currently executing the pre-heating operation (yes at S141), the CPU 101 shifts the processing to the processing at S151. At the start of the main processing, for example, the second heating device 5B is not yet executing the pre-heating operation. When the second heating device 5B is not currently executing the pre-heating operation (no at S141), the CPU 101 determines whether the number of execution reservations for the medium heating operation in the first heating device 5A is equal to or less than a target number of reservations (S142). The number of execution reservations for the medium heating operation in the first heating device 5A corresponds to the number of times for the medium heating operation to be executed in the predetermined period in the first heating device 5A. The target number of reservations is the same number as the target number of times of execution. The target number of reservations is a number of stand-by platens allowed by the user. The number of stand-by platens is a number of the platens 10 standing by until execution of the medium heating operation in the first heating device 5A. The target number of reservations is set in advance by the user, for example, via the receiver 104, and is stored in the flash memory 102.

When the number of execution reservations for the medium heating operation in the first heating device 5A exceeds the target number of reservations (no at S142), the CPU 101 starts the pre-heating operation in the second heating device 5B (S143). The CPU 101 shifts the processing to the processing at S151.

The CPU 101 conveys the target platen to the second heating device 5B (S151). When the application processing by the application device 3 has not yet been performed on the target platen, for example, the processing at S151 is performed subsequent to performing the application processing. In the processing at S151, the conveyance motor 701 of the transfer mechanism 84 is controlled in the state in which the target platen is disposed on the transfer mechanism 84 shown in FIG. 1, and the target platen is conveyed to the left and transferred to the branched path 88B. When the target platen is transferred to the branched path 88B and is conveyed to the second heating device 5B, the CPU 101 executes the medium heating operation in the second heating device 5B (S152). When the medium heating operation in the second heating device 5B is complete, the CPU 101 shifts the processing to a determination at S153.

As described above, when the non-operating heating device is present, the CPU 101 stops the heating operation by the non-operating heating device. Thus, when the medium heating operation is complete, the CPU 101 refers to the RAM 103, and determines whether there is the execution reservation for the medium heating operation in the second heating device 5B (S153). When there is no execution reservation for the medium heating operation in the second heating device 5B (no at S153), the CPU 101 stops the pre-heating operation in the second heating device 5B (S154). In this way, the temperature inside the second heating device 5B naturally falls. The CPU 101 returns the processing to the determination at S101 shown in FIG. 3.

When there is the execution reservation for the medium heating operation in the second heating device 5B (yes at S153), the CPU 101 skips the processing at S154, and returns the processing to the determination at S101 shown in FIG. 3. In this case, using the pre-heating operation in the second heating device 5B, or using the natural cooling in the second heating device 5B, the power supply to the heater 55B is controlled, namely, the heating or the stopping of the heater 55B is controlled, such that the detected temperature of the second heating device 5B becomes the next corresponding set temperature in the second heating device 5B. The next corresponding set temperature in the second heating device 5B is the set temperature corresponding to the print medium M placed on the platen 10 subsequent to the platen 10 for which the medium heating operation is complete in the processing at S152, in an execution order of the medium heating operation in the second heating device 5B.

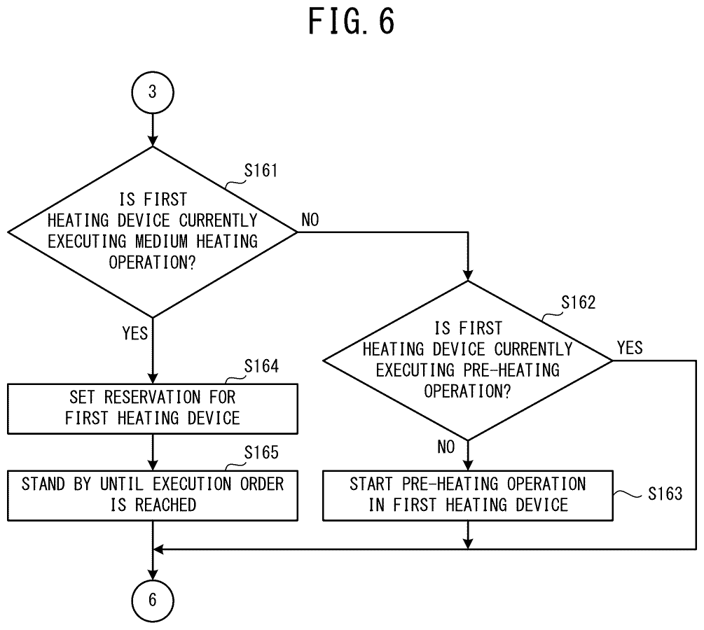

In the determination at S142, when the number of execution reservations for the medium heating operation in the first heating device 5A is equal to or less than the target number of reservations (yes at S142), the CPU 101 shifts the processing to a determination at S161 shown in FIG. 6. In this way, the stopping of the pre-heating operation in the second heating device 5B is maintained.

As shown in FIG. 6, the CPU 101 determines whether the first heating device 5A is currently executing the medium heating operation (S161). When the first heating device 5A is not currently executing the medium heating operation (no at S161), the CPU 101 determines whether the first heating device 5A is currently executing the pre-heating operation (S162). When the first heating device 5A is not currently executing the pre-heating operation (no at S162), the CPU 101 starts the pre-heating operation in the first heating device 5A (S163). The CPU 101 shifts the processing to the processing at S131 shown in FIG. 4. When the first heating device 5A is currently executing the pre-heating operation (yes at S162), the CPU 101 shifts the processing to S131 shown in FIG. 4, and performs the processing from S131 onward, as described above. In this case, the target platen is conveyed to the first heating device 5A.

When the first heating device 5A is currently executing the medium heating operation (yes at S161), the CPU 101 sets an execution reservation for the medium heating operation in the first heating device 5A (S164). The CPU 101 causes the target platen to stand by until the execution order for the medium heating operation in the first heating device 5A is reached (S165). For example, when a stand-by position for the platen 10 is provided between the transfer mechanism 84 and the first heating device 5A, in the processing at S165, the CPU 101 may convey the target platen to the stand-by position and cause the target platen to stand by at the stand-by position. When the execution order of the medium heating operation in the first heating device 5A is reached, the CPU 101 shifts the processing to the processing at S131 shown in FIG. 4, and performs the processing from S131 onward, as described above. In this case, the target platen is conveyed to the first heating device 5A.

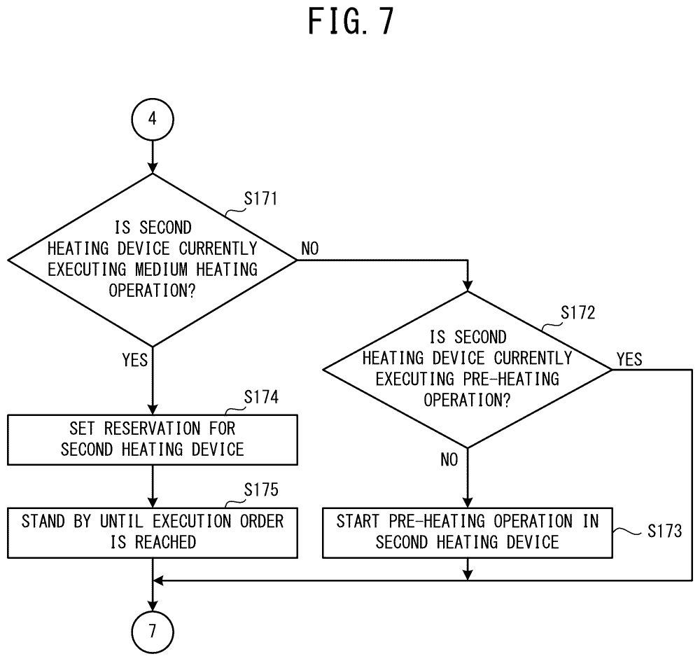

A case will be described in which, as a result of the conveyance destination determination processing (S113), the conveyance destination of the target platen is determined to be one of the first heating device 5A or the second heating device 5B. As shown in FIG. 3, the CPU 101 determines whether the conveyance destination of the target platen determined by the conveyance destination determination processing is the first heating device 5A (S114). When the conveyance destination of the target platen is the first heating device 5A (yes at S114), the CPU 101 shifts the processing to the processing at S161 shown in FIG. 6, and performs the processing from S161 onward, as described above. When the conveyance destination of the target platen is the second heating device 5B (no at S114), the CPU 101 shifts the processing to processing at S171 shown in FIG. 7.

As shown in FIG. 7, the CPU 101 determines whether the second heating device 5B is currently executing the medium heating operation (S171). When the second heating device 5B is not currently executing the medium heating operation (no at S171), the CPU 101 determines whether the second heating device 5B is currently executing the pre-heating operation (S172). When the second heating device 5B is not currently executing the pre-heating operation (no at S172), the CPU 101 starts the pre-heating operation in the second heating device 5B (S173). The CPU 101 shifts the processing to the processing at S151 shown in FIG. 5. When the second heating device 5B is currently executing the pre-heating operation (yes at S172), the CPU 101 shifts the processing to S151 shown in FIG. 5, and performs the processing from S151 onward, as described above. In this case, the target platen is conveyed to the second heating device 5B.

When the second heating device 5B is currently executing the medium heating operation (yes at S171), the CPU 101 sets an execution reservation for the medium heating operation in the second heating device 5B (S174). The CPU 101 causes the target platen to stand by until the execution order for the medium heating operation in the second heating device 5B is reached (S175). For example, when a stand-by position for the platen 10 is provided between the transfer mechanism 84 and the second heating device 5B, in the processing at S175, the CPU 101 may convey the target platen to the stand-by position and cause the target platen to stand by at the stand-by position. When the execution order of the medium heating operation in the second heating device 5B is reached, the CPU 101 shifts the processing to the processing at S151 shown in FIG. 5, and performs the processing from S151 onward, as described above. In this case, the target platen is conveyed to the second heating device 5B.

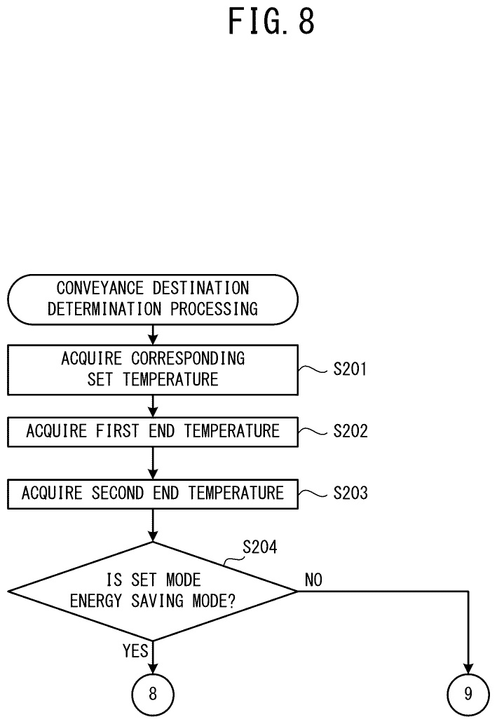

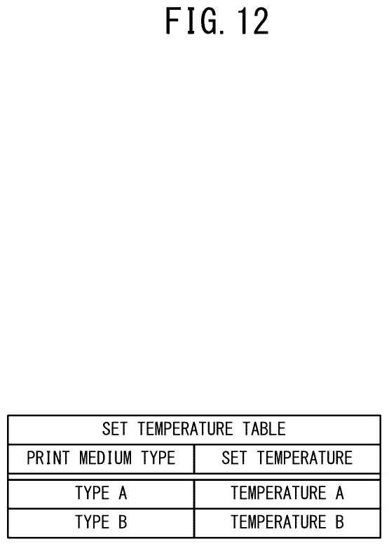

The conveyance destination determination processing will be described with reference to FIG. 8 to FIG. 11. As shown in FIG. 8, when the conveyance destination determination processing is started, the CPU 101 refers to a set temperature table shown in FIG. 12, and acquires the corresponding set temperature (S201). The set temperature table shown in FIG. 12 is stored in the flash memory 102. As shown in FIG. 12, the set temperature is associated with the type of the print medium M in the set temperature table. The type of the print medium M is defined by a type of fiber included in the print medium M, for example. The type of the fiber included in the print medium M is cotton, or synthetic fiber, for example. The synthetic fiber is polyester, for example.

In the example shown in FIG. 12, a temperature A is associated with a type A, and a temperature B is associated with a type B. The type A is cotton, for example, and the temperature A is 180° C., for example. The type B is the synthetic fiber, for example, and the temperature B is 110° C., for example.

Note that the type of the print medium M may be defined by the color of the print medium M, for example. The type of the print medium M may be defined by a type of the ink applied to the print medium M by the printer 2A or the printer 2B, for example, or may be defined by the type of the treatment liquid applied to the print medium M by the application device 3, for example. The type of the print medium M may be defined by an amount of the ink applied to the print medium M by the printer 2A or the printer 2B, for example, or may be defined by an amount of the treatment liquid applied to the print medium M by the application device 3, for example.

When the user places the print medium M on the platen 10, for example, the user inputs an identifier of the platen 10 and the type of the print medium M on the platen 10 to the system computer 100 via the receiver 104. The CPU 101 associates the received identifier of the platen 10 with the type of the print medium M on the platen 10, and stores the associated data in the RAM 103. In processing at S201, the CPU 101 identifies the type of the print medium M associated with the identifier of the target platen. The CPU 101 refers to the set temperature table and acquires the set temperature associated with the identified type of the print medium M, as the corresponding set temperature.

As shown in FIG. 8, the CPU 101 refers to the set temperature table shown in FIG. 12 and acquires a first end temperature (S202). The first end temperature is the set temperature in the medium heating operation currently being executed or the medium heating operation to be executed last, of the medium heating operation for which the execution reservation is set, by the first heating device 5A. In other words, when there is no execution reservation for the medium heating operation in the first heating device 5A, the first end temperature is the set temperature in the medium heating operation currently being executed in the first heating device 5A. When there is the execution reservation for the medium heating operation in the first heating device 5A, the first end temperature is the set temperature in the medium heating operation corresponding to the execution reservation that is last in the execution order in the first heating device 5A.

The CPU 101 refers to the set temperature table shown in FIG. 12 and acquires a second end temperature (S203). The second end temperature is the set temperature in the medium heating operation currently being executed or the medium heating operation to be executed last, of the medium heating operation for which the execution reservation is set, by the second heating device 5B. In other words, when there is no execution reservation for the medium heating operation in the second heating device 5B, the second end temperature is the set temperature in the medium heating operation currently being executed in the second heating device 5B. When there is the execution reservation for the medium heating operation in the second heating device 5B, the second end temperature is the set temperature in the medium heating operation corresponding to the execution reservation that is last in the execution order in the second heating device 5B.

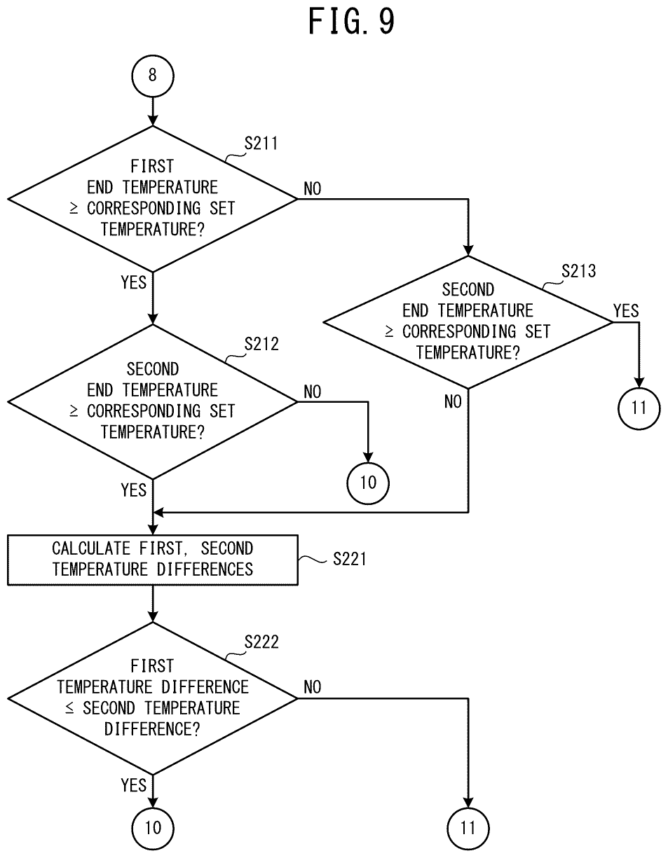

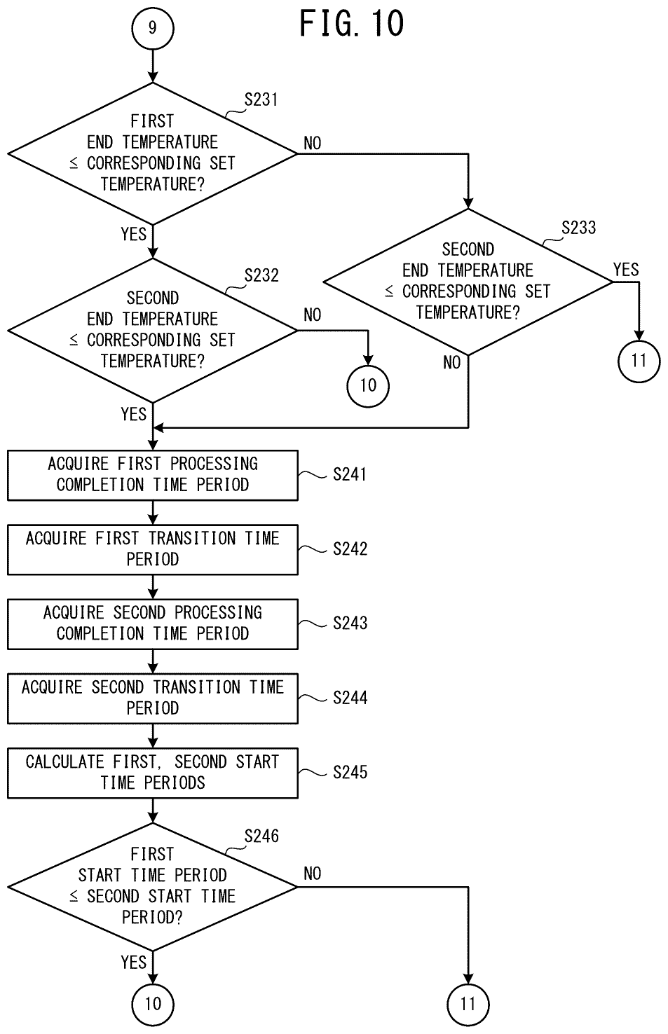

The CPU 101 refers to the flash memory 102, and determines whether the set mode is the energy saving mode (S204). When the set mode is the energy saving mode (yes at S204), the CPU 101 shifts the processing to processing at S211 shown in FIG. 9. When the set mode is the productivity mode (no at S204), the CPU 101 shifts the processing to processing at S231 shown in FIG. 10.

A case will be described in which the set mode is the energy saving mode (yes at S204). A “high temperature heating device” will be defined. The high temperature heating device is the heating device in which the first end temperature or the second end temperature exceeds the corresponding set temperature. For example, when the target platen has been conveyed to the high temperature heating device, the high temperature heating device lowers the temperature inside the high temperature heating device from the first end temperature or the second end temperature to the corresponding set temperature. In the present embodiment, the temperature inside the high temperature heating device is lowered from the first end temperature or the second end temperature to the corresponding set temperature by the natural cooling. In this case, compared to a case in which the temperature inside the heating device is raised from the first end temperature or the second end temperature to the corresponding set temperature using the heating operation by the heating device, it is easy to reduce the energy consumed until the temperature of the heating device becomes the corresponding set temperature from the first end temperature or the second end temperature. Thus, in the energy saving mode, when the high temperature heating device is present, the target platen is controlled to be conveyed to the high temperature heating device. In this way, in the energy saving mode, the CPU 101 controls the conveyance of the target platen to prioritize the control to suppress the energy consumption amount in the heating device, rather than improving the productivity mode in the heating device. This will be described in detail below.

As shown in FIG. 9, the CPU 101 determines whether the first end temperature acquired by the processing at S202 is equal to or greater than the corresponding set temperature acquired by the processing at S201 (S211). When the first end temperature is equal to or greater than the corresponding set temperature (yes at S211), the CPU 101 determines whether the second end temperature acquired by the processing at S203 is equal to or greater than the corresponding set temperature acquired by the processing at S201 (S212).

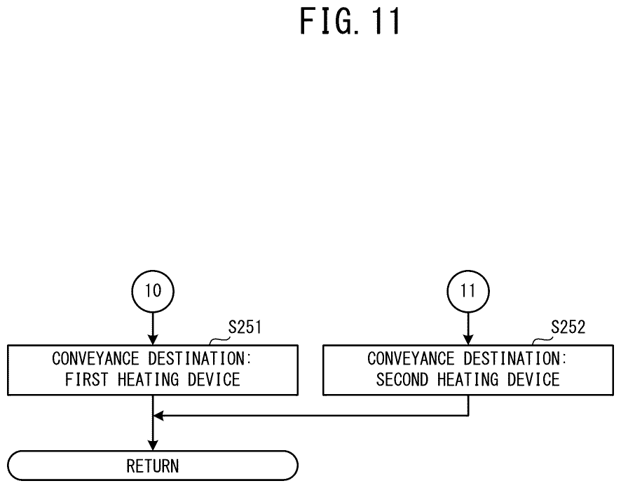

When the second end temperature is equal to or greater than the corresponding set temperature (yes at S212), the CPU 101 shifts the processing to processing at S221. When the second end temperature is less than the corresponding set temperature (no at S212), as shown in FIG. 11, the CPU 101 determines the conveyance destination of the target platen to be the first heating device 5A (S251). The CPU 101 returns the processing to the main processing shown in FIG. 3.

As shown in FIG. 9, in the determination at S211, when the first end temperature is less than the corresponding set temperature (no at S211), the CPU 101 determines whether the second end temperature acquired by the processing at S203 is equal to or greater than the corresponding set temperature acquired by the processing at S201 (S213). When the second end temperature is less than the corresponding set temperature (no at S213), the CPU 101 shifts the processing to the processing at S221. When the second end temperature is equal to or greater than the corresponding set temperature (yes at S213), as shown in FIG. 11, the CPU 101 determines the conveyance destination of the target platen to be the second heating device 5B (S252). The CPU 101 returns the processing to the main processing shown in FIG. 3.

As shown in FIG. 9, when both the first heating device 5A and the second heating device 5B correspond to the high temperature heating device (yes at S211, yes at S212), or when both the first heating device 5A and the second heating device 5B do not correspond to the high temperature heating device (no at S211, no at S213), it is necessary for the CPU 101 to determine to which of the first heating device 5A and the second heating device 5B the target platen is to be conveyed. Thus, the CPU 101 performs the processing from S221 onward.

In the processing at S221, the CPU 101 calculates a first temperature difference based on the corresponding set temperature acquired by the processing at S201 and the first end temperature acquired by the processing at S202, and calculates a second temperature difference based on the corresponding set temperature acquired by the processing at S201 and the second end temperature acquired by the processing at S203 (S221). The first temperature difference is an absolute value of a difference between the corresponding set temperature and the first end temperature. The second temperature difference is an absolute value of a difference between the corresponding set temperature and the second end temperature.

The CPU 101 determines whether the first temperature difference calculated by the processing at S221 is equal to or less than the second temperature difference calculated by the processing at S221 (S222). When the first temperature difference is equal to or less than the second temperature difference (yes at S222), as shown in FIG. 11, the CPU 101 determines the conveyance destination of the target platen to be the first heating device 5A (S251). As shown in FIG. 9, when the second temperature difference is less than the first temperature difference (no at S222), as shown in FIG. 11, the CPU 101 determines the conveyance destination of the target platen to be the second heating device 5B (S252).

A case will be described in which the set mode is the productivity mode (no at S204). A “low temperature heating device” will be defined. The low temperature heating device is the heating device in which the first end temperature or the second end temperature is less than the corresponding set temperature. For example, when the target platen has been conveyed to the low temperature heating device, the low temperature heating device raises the detected temperature from the first end temperature or the second end temperature to the corresponding set temperature, using the heating operation. In this case, compared to the case in which the detected temperature is lowered from the first end temperature or the second end temperature to the corresponding set temperature by the natural cooling, for example, it is easy to shorten a time required for the detected temperature to become the corresponding set temperature from the first end temperature or the second end temperature. Thus, in the productivity mode, when the low temperature heating device is present, the target platen is controlled to be conveyed to the low temperature heating device. In this way, in the productivity mode, the CPU 101 controls the conveyance of the target platen to prioritize improving the productivity, rather than suppressing the energy consumption amount in the heating device. This will be described in detail below.

As shown in FIG. 10, the CPU 101 determines whether the first end temperature acquired by the processing at S202 is equal to or less than the corresponding set temperature acquired by the processing at S201 (S231). When the first end temperature is equal to or less than the corresponding set temperature (yes at S231), the CPU 101 determines whether the second end temperature acquired by the processing at S203 is equal to or less than the corresponding set temperature acquired by the processing at S201 (S232).

When the second end temperature is equal to or less than the corresponding set temperature (yes at S232), the CPU 101 shifts the processing to processing at S241. When the second end temperature is more than the corresponding set temperature (no at S232), as shown in FIG. 11, the CPU 101 determines the conveyance destination of the target platen to be the first heating device 5A (S251).

As shown in FIG. 10, in the determination at S231, when the first end temperature exceeds the corresponding set temperature (no at S231), the CPU 101 determines whether the second end temperature acquired by the processing at S203 is equal to or less than the corresponding set temperature acquired by the processing at S201 (S233). When the second end temperature exceeds the corresponding set temperature (no at S233), the CPU 101 shifts the processing to the processing at S241. When the second end temperature is equal to or less than the corresponding set temperature (yes at S233), as shown in FIG. 11, the CPU 101 determines the conveyance destination of the target platen to be the second heating device 5B (S252).

As shown in FIG. 10, when both the first heating device 5A and the second heating device 5B correspond to the low temperature heating device (yes at S231, yes at S232), or when both the first heating device 5A and the second heating device 5B do not correspond to the low temperature heating device (no at S231, no at S233), it is necessary for the CPU 101 to determine to which of the first heating device 5A and the second heating device 5B the target platen is to be conveyed. Thus, the CPU 101 performs the processing from S241 onward.

In the processing at S241, the CPU 101 refers to the flash memory 102, and acquires a first processing completion time period (S241). The first processing completion time period is a time period required until completion of the medium heating operation currently being executed or the medium heating operation to be executed last, of the medium heating operation for which the execution reservation is set, by the first heating device 5A. In other words, when there is no execution reservation for the medium heating operation in the first heating device 5A, the first processing completion time period is a time period required until completion of the medium heating operation currently being executed in the first heating device 5A. When there is the execution reservation for the medium heating operation in the first heating device 5A, the first processing completion time period is a time period required until completion of the medium heating operation corresponding to the execution reservation that is last in the execution order in the first heating device 5A. A processing time period table (not shown in the drawings) is stored in the flash memory 102. Time periods required for one cycle of the medium heating operation corresponding to the types of the print medium M are set in the processing time period table, for example. The CPU 101 refers to the processing time period table, and acquires the first processing completion time period, based on the time period required for the one cycle of the medium heating operation corresponding to the type of the print medium M, and on the number of execution reservations for the medium heating operation in the first heating device 5A.

The CPU 101 refers to the flash memory 102 and acquires a first transition time period (S242). The first transition time period is a time period from when the first processing completion time period has elapsed to when the detected temperature in the first heating device 5A has reached the corresponding set temperature. In other words, the first transition time period is the time period taken for the detected temperature in the first heating device 5A to become the corresponding set temperature from the first end temperature. A transition time period table (not shown in the drawings) is stored in the flash memory 102. Time periods to reach a second temperature from a first temperature are set in the transition time period table. The CPU 101 takes the first end temperature as the first temperature, the corresponding set temperature as the second temperature, and refers to the transition time period table to acquire, as the first transition time period, the time period to reach the second temperature from the first temperature.

The CPU 101 refers to the flash memory 102 and acquires a second processing completion time period (S243). The second processing completion time period is a time period required until completion of the medium heating operation currently being executed or the medium heating operation to be executed last, of the medium heating operation for which the execution reservation is set, by the second heating device 5B. In other words, when there is no execution reservation for the medium heating operation in the second heating device 5B, the second processing completion time period is a time period required until completion of the medium heating operation currently being executed in the second heating device 5B. When there is the execution reservation for the medium heating operation in the second heating device 5B, the second processing completion time period is a time period required until completion of the medium heating operation corresponding to the execution reservation that is last in the execution order in the second heating device 5B. The CPU 101 refers to the processing time period table, and acquires the second processing completion time period, based on the time period required for the one cycle of the medium heating operation corresponding to the type of the print medium M, and on the number of execution reservations for the medium heating operation in the second heating device 5B.

The CPU 101 refers to the flash memory 102 and acquires a second transition time period (S244). The second transition time period is a time period from when the second processing completion time period has elapsed to when the detected temperature in the second heating device 5B has reached the corresponding set temperature. In other words, the second transition time period is the time period taken for the detected temperature in the second heating device 5B to become the corresponding set temperature from the second end temperature. The CPU 101 takes the second end temperature as the first temperature, the corresponding set temperature as the second temperature, and refers to the transition time period table to acquire, as the second transition time period, the time period to reach the second temperature from the first temperature.

The CPU 101 calculates a first start time period, based on the first processing completion time period acquired by the processing at S241 and the first transition time period acquired by the processing at S242, and calculates a second start time period, based on the second processing completion time period acquired by the processing at S243 and the second transition time period acquired by the processing at S244 (S245). The first start time period is a time period that is based on a sum of the first processing completion time period and the first transition time period, and in the present embodiment, is equivalent to the sum of the first processing completion time period and the first transition time period. For example, the time period required to convey the target platen to the first heating device 5A may be taken into account in the first start time period. The second start time period is a time period that is based on a sum of the second processing completion time period and the second transition time period, and is equivalent to the sum of the second processing completion time period and the second transition time period. For example, the time period required to convey the target platen to the second heating device 5B may be taken into account in the second start time period.

The CPU 101 determines whether the first start time period calculated by the processing at S245 is equal to or less than the second start time period calculated by the processing at S245 (S246). When the first start time period is equal to or less than the second start time period (yes at S246), as shown in FIG. 11, the CPU 101 determines the conveyance destination of the target platen to be the first heating device 5A (S251). As shown in FIG. 10, when the first start time period exceeds the second start time period (no at S246), as shown in FIG. 11, the CPU 101 determines the conveyance destination of the target platen to be the second heating device 5B (S252).

As described above, in the above-described embodiment, the CPU 101 controls the transfer mechanism 84, and conveys the target platen to one of the first heating device 5A or the second heating device 5B (S131 or S151). Thus, the print system 1 contributes to suppressing at least one of a deterioration in productivity or an increase in an energy consumption amount, in accordance with whether the target platen is conveyed to the first heating device 5A or the second heating device 5B.

When the target platen has been conveyed to the heating device that is not the empty heating device, there is a possibility that a waiting time may occur for the target platen until the medium heating operation. In the above-described embodiment, when the empty heating device is present (yes at S111 or yes at S112), the CPU 101 conveys the target platen to the empty heating device. Thus, the waiting time for the target platen until the medium heating operation is suppressed from occurring. Thus, the print system 1 contributes to suppressing a deterioration in productivity.

In the above-described embodiment, the CPU 101 acquires the first start time period and the second start time period (S245). When the first start time period is less than the second start time period (yes at S246), the CPU 101 conveys the target platen to the first heating device 5A. When the second start time period is less than the first start time period (no at S246), the CPU 101 conveys the target platen to the second heating device 5B. Thus, the target platen is conveyed to the heating device, of the first heating device 5A and the second heating device 5B, for which the start time period arrives first. Thus, the print system 1 contributes to suppressing the deterioration in productivity.

The smaller the difference between the end temperature and the corresponding set temperature, for example, the shorter the time period for the end temperature to become the corresponding set temperature. In the above-described embodiment, the CPU 101 acquires the corresponding set temperature, the first end temperature, and the second end temperature (S201, S202, and S203). When the first temperature difference is equal to or less than the second temperature difference (yes at S222), the CPU 101 conveys the target platen to the first heating device 5A. When the second temperature difference is less than the first temperature difference (no at S222), the CPU 101 conveys the target platen to the second heating device 5B. Thus, the target platen is conveyed to the heating device, of the first heating device 5A and the second heating device 5B, for which the time period for the end temperature to become the corresponding set temperature is shorter. Thus, the print system 1 contributes to suppressing the deterioration in productivity.

In the above-described embodiment, the CPU 101 acquires the corresponding set temperature, the first end temperature, and the second end temperature (S201, S202, and S203). When the low temperature heating device is present (yes at S231, or yes at S233), the CPU 101 conveys the target platen to the low temperature heating device. In this case, the print system 1 controls the temperature of the low temperature heating device to become the corresponding set temperature from the end temperature, by raising the detected temperature of the low temperature heating device. Thus, the print system 1 more easily controls the time period for the temperature inside the low temperature heating device to become the corresponding set temperature from the end temperature, than when performing control to lower the detected temperature from the end temperature to the corresponding set temperature. Thus, the print system 1 contributes to suppressing the deterioration in productivity.

In the above-described embodiment, the CPU 101 acquires the corresponding set temperature, the first end temperature, and the second end temperature (S201, S202, and S203). When the high temperature heating device is present (yes at S211, or yes at S213), the CPU 101 conveys the target platen to the high temperature heating device. In this case, the print system 1 performs the control to the corresponding set temperature by lowering the temperature inside the high temperature heating device from the end temperature. Thus, it is not necessary for the print system 1 to consume energy until the temperature inside the high temperature heating device becomes the corresponding set temperature. Thus, the print system 1 contributes to suppressing an increase in an energy consumption amount.

In the above-described embodiment, when, subsequent to the processing at S131 or at S151, the non-operating heating device is present (no at S133 or no at S153), the CPU 101 stops the pre-heating operation by the non-operating heating device. Thus, the print system 1 contributes to suppressing the increase in the energy consumption amount.

The receiver 104 receives the setting for one of the productivity mode or the energy saving mode. Based on whether the set mode is the productivity mode or the energy saving mode (S204), the CPU 101 conveys the target platen to one of the first heating device 5A or the second heating device 5B. In this case, the print system 1 contributes to allowing the user to select which to prioritize, of the improvement in productivity or the suppression of the energy consumption amount.

The CPU 101 conveys the target platen to the first heating device 5A until the number of times of the medium heating operation executed in the first heating device 5A in the predetermined time period reaches the target number of times for the medium heating operation to be executed in the predetermined time period (yes at S142). The CPU 101 maintains the stopping of the pre-heating operation in the second heating device 5B until the number of times of the medium heating operation executed in the first heating device 5A in the predetermined time period reaches the target number of times for the medium heating operation to be executed in the predetermined time period (yes at S142). In this case, the print system 1 contributes to suppressing the increase in the energy consumption amount while securing a target productivity.

In the above-described embodiment, the unit of the system computer 100 and the conveyance device 7 is an example of the “conveyance control device” of the present disclosure. The print medium M is an example of the “print medium” of the present disclosure. The platen 10 is an example of the “platen” of the present disclosure. The transfer mechanism 84 is an example of the “conveyor” of the present disclosure. The printer 2A and 2B are an example of the “printer” of the present disclosure. The first heating device 5A is an example of the “first heater” of the present disclosure. The second heating device 5B is an example of the “second heater” of the present disclosure. The CPU 101 is an example of the “processor” of the present disclosure. The processing at S131 and S151 is an example of the “conveyance processing” of the present disclosure. The receiver 104 is an example of the “receiver” of the present disclosure. The system computer 100 is an example of the “computer” of the present disclosure. The first end temperature is an example of the “first heating temperature” of the present disclosure. The second end temperature is an example of the “second heating temperature” of the present disclosure.

Note that, in the above-described embodiment, the description is made in which, in the main processing, the platen 10 is conveyed to one of the first heating device 5A or the second heating device 5B. In the above-described embodiment, in the main processing, the CPU 101 performs the same control as for the conveyance of the platen 10 to one of the first heating device 5A or the second heating device 5B with respect to the conveyance of the platen 10 to one of the first heating device 6A or the second heating device 6B also. In this case, in the above-described main processing, it is sufficient to read the first heating device 6A for the first heating device 5A, and to read the second heating device 6B for the second heating device 5B. In this case, in the conveyance device 7, the determination position P1 is provided at any position from the set position P0 to the transfer mechanism 86. In the conveyance device 7, the determination position P1 is preferably provided at any position from the transfer mechanism 85 to the transfer mechanism 86. In the conveyance device 7, the determination position P1 is preferably disposed at a position through which the platen 10 on which the print processing by the printer 2A or the printer 2B has not yet been performed does not pass, and through which the platen 10 on which the print processing has been performed by the printer 2A or the printer 2B does pass. In the processing at S131 or at S151, when the print processing by the printer 2A or the printer 2B has not yet been performed on the target platen, the conveyance of the target platen to the first heating device 6A or to the second heating device 6B is performed subsequent to performing the print processing. Also when controlling the conveyance of the platen 10 to one of the first heating device 6A or the second heating device 6B, the print system 1 contributes to the same effects as when controlling the conveyance of the platen 10 to one of the first heating device 5A or the second heating device 5B, as described above.

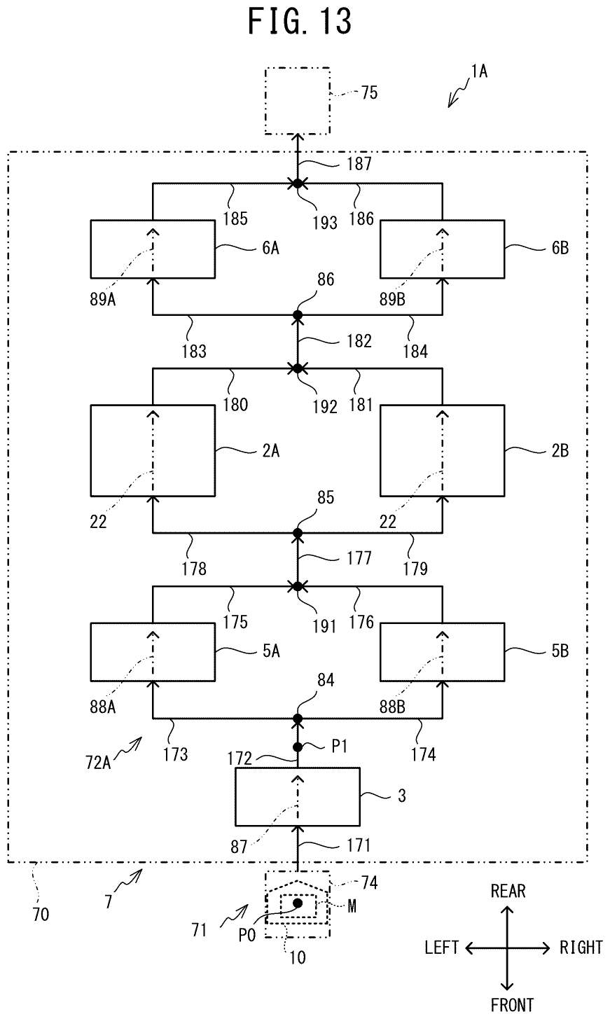

While the invention has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the invention, and not limiting the invention. Various changes may be made without departing from the spirit and scope of the disclosure. Therefore, the disclosure is intended to embrace all known or later developed alternatives, modifications, variations, improvements, and/or substantial equivalents. Some specific examples of potential alternatives, modifications, or variations in the described invention are provided below. The above-described embodiment and each of modified examples may be combined with each other insofar as no contradictions arise. A print system 1A will be described with reference to FIG. 13. In the print system 1A, configurations having the equivalent function as that of the print system 1 will be assigned the same reference signs as those of the above-described embodiment, and a description thereof will be simplified or omitted.

The print system 1A differs from the above-described embodiment in that a conveyance device 7A is further provided with transfer mechanisms 191, 192, and 193, and in place of the outward path 72 shown in FIG. 1, the main path 71 is provided with an outward path 72A. A detailed structure of each of the transfer mechanisms 191, 192, and 193 is the same as that of the transfer mechanism 84 shown in FIG. 1, for example. The outward path 72A is provided with conveyance paths 171 to 187. A detailed structure of each of the conveyance paths 171 to 187 is the same as that of the main path 71 shown in FIG. 1, for example.

The conveyance path 171 is connected to the elevator mechanism 74, extends to the rear from the elevator mechanism 74, and is connected to the front end of the branched path 87. The conveyance path 172 is connected to the rear end of the branched path 87, extends to the rear from the rear end of the branched path 87, and is connected to the transfer mechanism 84. The conveyance path 173 is connected to the transfer mechanism 84, extends to the left from the transfer mechanism 84, and is connected to the front end of the branched path 88A. The conveyance path 175 is connected to the rear end of the branched path 88A, extends to the rear from the rear end of the branched path 88A, and is connected to the transfer mechanism 191.

The conveyance path 174 is connected to the transfer mechanism 84, extends to the right from the transfer mechanism 84, and is connected to the front end of the branched path 88B. The conveyance path 176 is connected to the rear end of the branched path 88B, extends to the rear from the rear end of the branched path 88B, and is connected to the transfer mechanism 191.

The conveyance path 177 is connected to the transfer mechanism 191, extends to the rear from the transfer mechanism 191, and is connected to the transfer mechanism 85. The conveyance path 178 is connected to the transfer mechanism 85, extends to the left from the transfer mechanism 85, and is connected to the front end of the sub-scanning conveyance mechanism 22 of the printer 2A. The conveyance path 179 is connected to the transfer mechanism 85, extends to the right from the transfer mechanism 85, and is connected to the front end of the sub-scanning conveyance mechanism 22 of the printer 2B.

The conveyance path 180 is connected to the rear end of the sub-scanning conveyance mechanism 22 of the printer 2A, extends to the right from the rear end of the sub-scanning conveyance mechanism 22 of the printer 2A, and is connected to the transfer mechanism 192. The conveyance path 181 is connected to the rear end of the sub-scanning conveyance mechanism 22 of the printer 2B, extends to the rear from the sub-scanning conveyance mechanism 22 of the printer 2B, and is connected to the transfer mechanism 192.

The conveyance path 182 is connected to the transfer mechanism 192, extends to the rear from the transfer mechanism 192, and is connected to the transfer mechanism 86. The conveyance path 183 is connected to the transfer mechanism 86, extends to the left from the transfer mechanism 86, and is connected to the front end of the branched path 89A. The conveyance path 184 is connected to the transfer mechanism 86, extends to the right from the transfer mechanism 86, and is connected to the front end of the branched path 89B.

The conveyance path 185 is connected to the rear end of the branched path 89A, extends to the rear from the rear end of the branched path 89A, and is connected to the transfer mechanism 193. The conveyance path 186 is connected to the rear end of the branched path 89B, extends to the rear from the rear end of the branched path 89B, and is connected to the transfer mechanism 193. The conveyance path 187 is connected to the transfer mechanism 193, extends to the rear from the transfer mechanism 193, and is connected to the elevator mechanism 75.

According to the print system 1A, the platen 10 is conveyed from the elevator mechanism 74 to the transfer mechanism 84 in the order of the conveyance path 171, the branched path 87, and the conveyance path 172. The platen 10 is conveyed from the transfer mechanism 84 to the conveyance path 173 or to the conveyance path 174. For example, when the platen 10 is conveyed to the conveyance path 173, the platen 10 is conveyed from the transfer mechanism 84 to the transfer mechanism 191 in the order of the conveyance path 173, the branched path 88A, and the conveyance path 175. The platen 10 is conveyed from the transfer mechanism 191 to the transfer mechanism 85 via the conveyance path 177.

The platen 10 is conveyed from the transfer mechanism 85 to the conveyance path 178 or 179. For example, when the platen 10 is conveyed to the conveyance path 178, the platen 10 is conveyed from the transfer mechanism 85 to the transfer mechanism 192 in the order of the conveyance path 177, the sub-scanning conveyance mechanism 22, and the conveyance path 180. The platen 10 is conveyed from the transfer mechanism 192 to the transfer mechanism 86 via the conveyance path 182.

The platen 10 is conveyed from the transfer mechanism 86 to the conveyance path 183 or 184. For example, when the platen 10 is conveyed to the conveyance path 183, the platen 10 is conveyed from the transfer mechanism 86 to the transfer mechanism 193 in the order of the conveyance path 183, the branched path 89A, and the conveyance path 185. The platen 10 is conveyed from the transfer mechanism 193 to the elevator mechanism 75 via the conveyance path 187.

In the print system 1A, on the conveyance path 173, for example, a stand-by position may be provided at which the platen 10 stands by until the execution order for the medium heating operation in the first heating device 5A is reached. On the conveyance path 174, for example, a stand-by position may be provided at which the platen 10 stands by until the execution order for the medium heating operation in the second heating device 5B is reached. On the conveyance path 183, a stand-by position may be provided at which the platen 10 stands by until the execution order for the medium heating operation in the first heating device 6A is reached. On the conveyance path 184, for example, a stand-by position may be provided at which the platen 10 stands by until the execution order for the medium heating operation in the second heating device 6B is reached.

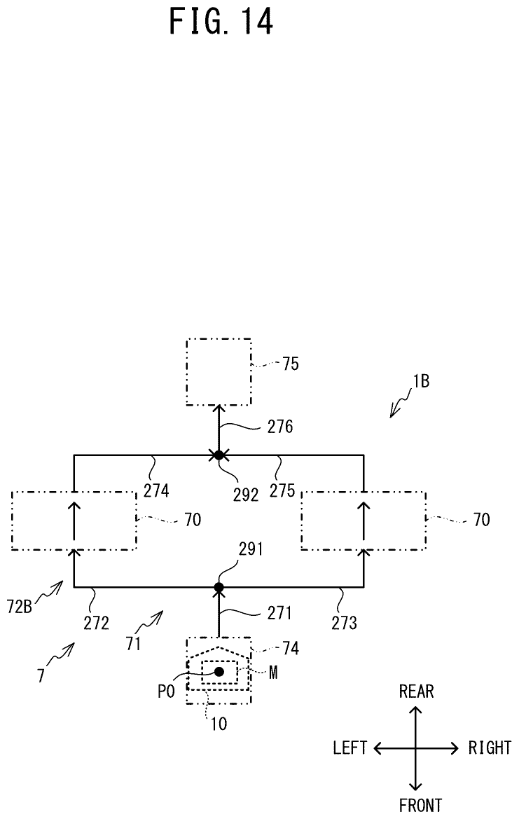

A print system 1B will be described with reference to FIG. 14. In the print system 1B, configurations having the equivalent function as that of the print system 1 or the print system 1A will be assigned the same reference signs as those of the print system 1 and the print system 1A, and a description thereof will be simplified or omitted. Hereinafter, as shown in FIG. 13, the outward path 72A from the conveyance path 171 to the conveyance path 187, the application device 3, the first heating device 5A, the second heating device 5B, the printers 2A and 2B, the first heating device 6A, and the second heating device 6B will be referred to as a “printing unit 70”.

The print system 1B differs from the print system 1A in that the conveyance device 7 is further provided with transfer mechanisms 291 and 292, and the main path 71 is provided with an outward path 72B is provided in place of the outward path 72A shown in FIG. 13. A detailed structure of each of the transfer mechanisms 291 and 292 is the same as that of the transfer mechanism 84 shown in FIG. 1, for example. The outward path 72B is provided with a plurality of the printing units 70, and conveyance paths 271 to 276. A detailed structure of each of the conveyance paths 271 to 276 is the same as that of the main path 71 shown in FIG. 1, for example.

The plurality of printing units 70 are aligned between the elevator mechanisms 74 and 75. A number of the plurality of printing units 70 is not limited to a particular number, and may be two, for example. The conveyance path 271 is connected to the elevator mechanism 74, extends to the rear from the elevator mechanism 74, and is connected to the transfer mechanism 291. The conveyance path 272 is connected to the transfer mechanism 291, extends to the left from the transfer mechanism 291, and is connected to the front end of the conveyance path 171 (refer to FIG. 13) of the printing unit 70 on the left. The conveyance path 273 is connected to the transfer mechanism 291, extends to the right from the transfer mechanism 291, and is connected to the front end of the conveyance path 171 (refer to FIG. 13) of the printing unit 70 on the right.

The conveyance path 274 is connected to the rear end of the conveyance path 187 (refer to FIG. 13) of the printing unit 70 on the left, extends to the rear from the conveyance path 187, and is connected to the transfer mechanism 292. The conveyance path 275 is connected to the rear end of the conveyance path 187 (refer to FIG. 13) of the printing unit 70 on the right, extends to the rear from the conveyance path 187, and is connected to the transfer mechanism 292. The conveyance path 276 is connected to the transfer mechanism 292, extends to the rear from the transfer mechanism 292, and is connected to the elevator mechanism 75.

According to the print system 1B, the platen 10 is conveyed from the elevator mechanism 74 to the transfer mechanism 291 via the conveyance path 271. The platen 10 is conveyed from the transfer mechanism 291 to the conveyance path 272 or 273. When the platen 10 is conveyed to the conveyance path 272, for example, the platen 10 is conveyed to the conveyance path 171 (refer to FIG. 13) of the printing unit 70 on the left. In this case, the platen 10 is conveyed from the conveyance path 187 (refer to FIG. 13) of the printing unit 70 on the left to the transfer mechanism 292 via the conveyance path 274. The platen 10 is conveyed from the transfer mechanism 292 to the elevator mechanism 75 via the conveyance path 276.

Another modified example will be described. In the above-described embodiment, the print system 1 may omit one of the printers 2A or 2B. The print system 1 may be provided with another one or plurality of printers in addition to the printers 2A and 2B. The printers 2A and 2B may be changed from the inkjet printer, and may be a laser printer, and thermal printer, or the like. The printers 2A and 2B may be different types of printer from each other.

The print system 1 may omit the application device 3. The print system 1 may be provided with another one or plurality of application devices in addition to the application device 3. When the print system 1 is provided with the first heating device 6A and the second heating device 6B, one or both of the first heating device 5A and the second heating device 5B may be omitted. The print system 1 may be provided with another one or plurality of heating devices in addition to the first heating device 5A and the second heating device 5B. When the print system 1 is provided with the first heating device 5A and the second heating device 5B, one or both of the first heating device 6A and the second heating device 6B may be omitted. The print system 1 may be provided with another one or plurality of heating devices in addition to the first heating device 6A and the second heating device 6B.

In the above-described embodiment, the number of the printers 2A and 2B (two), the number of the first heating device 5A and the second heating device 5B (two), and the number of the first heating device 6A and the second heating device 6B (two) may be different from each other. For example, the number of the first heating devices 5A and the second heating devices 5B may be three with respect to the two printers 2A and 2B.

In the above-described embodiment, the first heating device 5A is the air blower dryer. In contrast to this, the first heating device 5A may be a heat press device instead of the air blower dryer, or may include the air blower dryer and the heat press device. For example, when the first heating device 5A is the heat press device, the first heating device 5A may be provided with a press mechanism instead of the fan 56A. In this case, the heater 55A may heat the press mechanism. For example, when the first heating device 5A includes the air blower dryer and the heat press device, a number of the air blower dryers and the heat press devices may be the same, or may be different from each other. The air blower dryers and the heat press devices may be arranged in series, or may be arranged in parallel to each other. Each of the second heating device 5B, the first heating device 6A, and the second heating device 6B may be changed in a similar manner to the first heating device 5A.

Each of the first heating device 5A and the second heating device 5B may have a configuration that differs from that of the first heating device 6A and the second heating device 6B. For example, when both the first heating device 5A and the second heating device 5B include the air blower dryer and the heat press device, both the first heating device 6A and the second heating device 6B may be the air blower dryers.

The conveyance device 7 conveys the platen 10 such that the application processing, the treatment liquid drying processing, the print processing, and the ink drying processing are performed in order. In contrast to this, the conveyance device 7 may convey the platen 10 such that the treatment liquid drying processing is skipped, or such that both the application processing and the treatment liquid drying processing are skipped. The conveyance device 7 may convey the platen 10 such that the ink drying processing is skipped.

In the above-described embodiment, in the determination at S211, for example, when the first end temperature is equivalent to the corresponding set temperature, the CPU 101 may shift the processing to the determination at S213. In a similar manner, in processing to compare two values, when the two values are equivalent to each other, the CPU 101 may shift the processing to processing other than the processing to which the processing is shifted in the above-described embodiment.

In the above-described embodiment, the energy saving mode and the productivity mode need not necessarily be provided. In this case, the CPU 101 may omit the determination at S204, and may perform one of the processing from S211 onward or the processing from S231 onward.

The CPU 101 may acquire the detected temperature of the first heating device 5A instead of the first end temperature in the processing at S202, and may acquire the detected temperature of the second heating device 5B instead of the second end temperature in the processing at S203. In this case, in the determinations from S204 onward, the CPU 101 may perform a determination based on the detected temperature of the first heating device 5A instead of the first end temperature, and may perform a determination based on the detected temperature of the second heating device 5B instead of the second end temperature. In the determination at S211, for example, the CPU 101 may perform the determination based on the detected temperature of the first heating device 5A, and in the determination at S212, the CPU 101 may perform the determination based on the detected temperature of the second heating device 5B.

When both the first heating device 5A and the second heating device 5B are the high temperature heating device (yes at S211, yes at S212), the CPU 101 may perform the processing from S241 onward instead of the processing from S221 onward. When both the first heating device 5A and the second heating device 5B are not the high temperature heating device (no at S211, no at S213), the CPU 101 may perform the processing from S241 onward instead of the processing from S221 onward.

When both the first heating device 5A and the second heating device 5B are the low temperature heating device (yes at S231, yes at S232), the CPU 101 may perform the processing from S221 onward instead of the processing from S241 onward. When both the first heating device 5A and the second heating device 5B are not the low temperature heating device (no at S231, no at S233), the CPU 101 may perform the processing from S221 onward instead of the processing from S241 onward.

When the set mode is the energy saving mode (yes at S204), the CPU 101 may omit the determinations at S211, S212, and S213, and may shift the processing to the processing at S221. When the set mode is the productivity mode (no at S204), the CPU 101 may omit the determinations at S231, S232, and S233, and may shift the processing to the processing at S241. When the target platen has reached the determination position P1 (yes at S103), the CPU 101 may shift the processing to the processing at S221, or may shift the processing to the processing at S241.

In the above-described embodiment, when the empty heating device is not present (no at S111, no at S112), the CPU 101 performs the conveyance destination determination processing (S113). In contrast to this, the CPU 101 need not necessarily perform the conveyance destination determination processing, and may cause the target platen to stand by until the empty heating device is present. In this case, the CPU 101 need not necessarily store the execution reservation for the medium heating operation in the RAM 103. The CPU 101 may omit one or both of the determinations at S111 and at S112. For example, when the determinations at both S111 and S112 are omitted, the CPU 101 may perform the conveyance destination determination processing (S113) when the target platen has reached the determination position P1 (yes at S103), regardless of whether or not the empty heating device is present.

In the above-described embodiment, the empty heating device is defined as the heating device that is not currently executing the medium heating operation, and for which there is no execution reservation for the medium heating operation. In contrast to this, the empty heating device may be the heating device that is not currently executing the medium heating operation, regardless of whether or not there is the execution reservation for the medium heating operation. In this case also, the print system 1 contributes to suppressing the deterioration in productivity.

In the above-described embodiment, when the second heating device 5B is the empty heating device (yes at S112), the target platen may be conveyed to the second heating device 5B (S151), regardless of the number of execution reservations for the medium heating operation in the first heating device 5A. In other words, when the second heating device 5B is not currently executing the pre-heating operation (no at S141), the CPU 101 may omit the determination at S142, and may shift the processing to the processing at S143.

The CPU 101 may omit the determination at S133 and the processing at S134. The CPU 101 may omit the determination at S153 and the processing at S154. In other words, even when the non-operating heating device is present, the CPU 101 need not necessarily stop the pre-heating operation in the non-operating heating device.

In the above-described embodiment, the platen 10 is conveyed by the conveyance path. In contrast to this, the platen 10 may be conveyed by a robot. In this case, the target platen is conveyed to one of the first heating device 5A or the second heating device 5B as a result of the robot carrying the target platen.

The first heating device 5A and the second heating device 5B need not necessarily be separate devices. In other words, the first heating device 5A and the second heating device 5B may respectively configure a part of a single device, and may be integrally provided as the single device. For example, the first heating device 5A and the second heating device 5B may be provided in a two-level structure of being aligned in the up-down direction. In a similar manner, the first heating device 6A and the second heating device 6B need not necessarily be the separate devices.

A first calculated value and a second calculated value will be defined. The n-th power of the absolute value of the difference between the first end temperature and the corresponding set temperature is a “first temperature parameter”. The first calculated value is a sum value of the first completion time period, the first transition time period, and a coefficient k×the first temperature parameter. The n-th power of the absolute value of the difference between the second end temperature and the corresponding set temperature is a “second temperature parameter”. The second calculated value is a sum value of the second completion time period, the second transition time period, and the coefficient k×the second temperature parameter. n may be a positive integer, or may be a negative integer. For example, in the processing at S211 or at S245, the CPU 101 may calculate the first calculated value based on the first completion time period, the first transition time period, the first end temperature, the corresponding set temperature, and the coefficient k, and may calculate the second calculated value based on the second completion time period, the second transition time period, the second end temperature, the corresponding set temperature, and the coefficient k. For example, in the determination at S222 or at S246, the CPU 101 may determine whether the first calculated value is less than the second calculated value. When the first calculated value is less than the second calculated value, the CPU 101 may determine the conveyance destination of the target platen to be the first heating device 5A (S251). When the second calculated value is less than the first calculated value, the CPU 101 may determine the conveyance destination of the target platen to be the second heating device 5B (S252). In this case, the CPU 101 may set the value of the coefficient k in accordance with the set mode. For example, when the set mode is the energy saving mode, the CPU 101 may set a value k1 as the coefficient k, and when the set mode is the productivity mode, may set a value k2 as the coefficient k. In this case, as long as n is the positive integer, the coefficient k2 may be equal to or greater than zero, and be less than the coefficient k1.

In the above-described embodiment, the system computer 100 controls each of the application device 3, the first heating device 5A, the second heating device 5B, the first heating device 6A, the second heating device 6B, and the conveyance device 7. In contrast to this, in place of or in addition to the system computer 100, the print system 1 may be respectively provided with a computer controlling the application device 3, a computer controlling the first heating device 5A, a computer controlling the second heating device 5B, a computer controlling the first heating device 6A, a computer controlling the second heating device 6B, and a computer controlling the conveyance device 7. In this case, for example, the computer controlling the conveyance device 7 may perform the main processing. When the computer controlling the conveyance device 7 performs the main processing, in the determination at S111, for example, the computer controlling the conveyance device 7 may acquire information from the computer controlling the first heating device 5A indicating whether the first heating device 5A is the empty heating device, and may determine whether the first heating device 5A is the empty heating device based on the acquired information. In the other determinations in the main processing, the computer controlling the conveyance device 7 may perform each of the determinations based on information acquired from the other computers.

In place of the CPU 101, a microcomputer, application specific integrated circuits (ASICs), a field programmable gate array (FPGA) or the like may be used as a processor. The main processing may be performed as distributed processing by a plurality of the processors. It is sufficient that the non-transitory storage media, such as the flash memory 102, and the like be a storage medium capable of storing information, regardless of a period of storing the information. The non-transitory storage medium need not necessarily include a transitory storage medium (a transmitted signal, for example). The control program may be downloaded from a server connected to a network (not shown in the drawings) (in other words, may be transmitted as transmission signals), and may be stored in the flash memory 102. In this case, the control program may be stored in a non-transitory storage medium, such as an HDD provided in the server.

What is claimed is:

1. A conveyance control device comprising:
a conveyor configured to convey a platen on which a print medium is placed;
a first heater and a second heater connected to a printer, the printer being configured to perform printing on the print medium on the platen, the first heater and the second heater being configured to execute a medium heating operation to heat the print medium on the platen;
a processor, and
a memory storing computer-readable instructions that, when executed by the processor, instruct the processor to perform a process comprising:
controlling the conveyor and conveying a target platen to one of the first heater or the second heater, the target platen being the platen on which the print medium is placed and being a control target.

2. The conveyance control device according to claim 1, wherein
the computer-readable instructions instruct the processor to perform a process comprising:
conveying, when an empty heater is present, the target platen to the empty heater, and
the empty heater is a heater, of the first heater and the second heater, that is not currently executing the medium heating operation.

3. The conveyance control device according to claim 2, wherein
the computer-readable instructions instruct the processor to perform a process comprising:
conveying, when the empty heater is present, the target platen to the empty heater, and
the empty heater is the heater, of the first heater and the second heater, that is not currently executing the medium heating operation and for which an execution reservation is not set.

4. The conveyance control device according to claim 1, wherein
the computer-readable instructions instruct the processor to perform a process comprising:
acquiring a first start time period and a second start time period,
the first start time period is a time period calculated based on a sum of a first processing completion time period and a first transition time period,
the first processing completion time period is a time period required until completion of the medium heating operation currently being executed or the medium heating operation to be executed last, of the medium heating operation for which the execution reservation is set, in the first heater,
the first transition time period is a time period until a first heating temperature by the first heater reaches a corresponding set temperature from when the first processing completion time period elapses,
the corresponding set temperature is a temperature according with the print medium placed on the target platen, from among set temperatures set in accordance with the print media,
the second start time period is a time period calculated based on a sum of a second processing completion time period and a second transition time period,
the second processing completion time period is a time period required until completion of the medium heating operation currently being executed or the medium heating operation to be executed last, of the medium heating operation for which the execution reservation is set, in the second heater,
the second transition time period is a time period until a second heating temperature by the second heater reaches the corresponding set temperature from when the second processing completion time period elapses, and
the computer-readable instructions instruct the processor to perform processes comprising:
conveying, when the first start time period is less than the second start time period, the target platen to the first heater, and
conveying, when the second start time period is less than the first start time period, the target platen to the second heater.

5. The conveyance control device according to claim 1, wherein
the computer-readable instructions instruct the processor to perform a process comprising:
acquiring a corresponding set temperature, a first heating temperature by the first heater, and a second heating temperature by the second heater,
the corresponding set temperature is a temperature according with the print medium placed on the target platen, from among set temperatures set in accordance with the print media, and
the computer-readable instructions instruct the processor to perform processes comprising:
conveying, when a difference between the corresponding set temperature and the first heating temperature is less than a difference between the corresponding set temperature and the second heating temperature, the target platen to the first heater, and
conveying, when the difference between the corresponding set temperature and the second heating temperature is less than the difference between the corresponding set temperature and the first heating temperature, the target platen to the second heater.

6. The conveyance control device according to claim 1, wherein
the computer-readable instructions instruct the processor to perform a process comprising:
acquiring a corresponding set temperature, a first heating temperature by the first heater, and a second heating temperature by the second heater,
the corresponding set temperature is a temperature according with the print medium placed on the target platen, from among set temperatures set in accordance with the print media,
the computer-readable instructions instruct the processor to perform processes comprising:
conveying, when a low temperature heater is present, the target platen to the low temperature heater, and
the low temperature heater is the first heater in which the first heating temperature is less than the corresponding set temperature or the second heater in which the second heating temperature is less than the corresponding set temperature.

7. The conveyance control device according to claim 1, wherein
the computer-readable instructions instruct the processor to perform a process comprising:
acquiring a corresponding set temperature, a first heating temperature by the first heater, and a second heating temperature by the second heater,
the corresponding set temperature is a temperature according with the print medium placed on the target platen, from among set temperatures set in accordance with the print media,
the computer-readable instructions instruct the processor to perform a process comprising:
conveying, when a high temperature heater is present, the target platen to the high temperature heater, and
the high temperature heater is the first heater in which the first heating temperature exceeds the corresponding set temperature or the second heater in which the second heating temperature exceeds the corresponding set temperature.

8. The conveyance control device according to claim 1, wherein
the computer-readable instructions instruct the processor to perform a process comprising:
stopping, when, subsequent to the target platen being conveyed to one of the first heater or the second heater, a non-operating heater is present, heating by the non-operating heater, and
the non-operating heater is a heater, of the first heater and the second heater, for which the execution reservation for the medium heating operation is not set.

9. The conveyance control device according to claim 1, further comprising:
a receiver configured to receive a setting of one of a productivity mode prioritizing an improvement in productivity in the first heater and the second heater, and an energy saving mode prioritizing a suppression of an energy consumption amount in the first heater and the second heater, wherein
the computer-readable instructions instruct the processor to perform a process comprising:
conveying the target platen to one of the first heater or the second heater based on whether the setting received by the receiver is the setting for the productivity mode or is the setting for the energy saving mode.

10. The conveyance control device according to claim 1, wherein
the computer-readable instructions instruct the processor to perform processes comprising:
conveying the target platen to the one of the first heater or the second heater until a number of times of execution of the medium heating operation in one of the first heater or the second heater reaches a target number of times of execution of the medium heating operation within a predetermined time period, and
maintaining stopping of heating by another of the first heater or the second heater until the number of times of execution of the medium heating operation in the one of the first heater or the second heater reaches the target number of times of execution of the medium heating operation within the predetermined time period.

11. A conveyance control method of a conveyance control device comprising a conveyor configured to convey a platen on which a print medium is placed and a first heater and a second heater connected to a printer, the printer being configured to perform printing on the print medium on the platen, the first heater and the second heater being configured to execute a medium heating operation to heat the print medium on the platen, the conveyance control method comprising:
conveyance processing of controlling the conveyor and conveying a target platen to one of the first heater or the second heater, the target platen being the platen on which the print medium is placed and being a control target.

12. A non-transitory computer-readable medium storing computer-readable instructions that, when executed by a computer, instruct the computer to perform a process, the computer controlling a conveyance control device, the conveyance control device comprising a conveyor configured to convey a platen on which a print medium is placed and a first heater and a second heater connected to a printer, the printer being configured to perform printing on the print medium on the platen, the first heater and the second heater being configured to execute a medium heating operation to heat the print medium on the platen, the process comprising:
conveyance processing of controlling the conveyor and conveying a target platen to one of the first heater or the second heater, the target platen being the platen on which the print medium is placed and being a control target.
